(19) United States
(12) Patent Application Publication
(10) Pub. No.: US 2017/0145145 A1
(43) Pub. Date: May 25, 2017

(54) RENEWABLY DERIVED THERMOPLASTIC POLYESTER-BASED URETHANES AND METHODS OF MAKING AND USING THE SAME

(71) Applicant: Trent University, Peterborough (CA)

(72) Inventors: Suresh Narine, Peterborough (CA); Shegufta Shetranjiwalla, Peterborough (CA); Shaojun Li, Peterborough (CA); Laziz Bouzidi, Peterborough (CA)

(21) Appl. No.: 15/361,174

(22) Filed: Nov. 25, 2016

Related U.S. Application Data
(60) Provisional application No. 62/259,771, filed on Nov. 25, 2015.

(51) Int. Cl. C08G 18/10; C08G 18/42; C08G 18/32; C08G 18/73

(52) U.S. Cl. CPC C08G 18/10; C08G 18/73; C08G 18/4236; C08G 18/3206

(57) ABSTRACT

The disclosure generally provides high-molecular-weight thermoplastic polyester-based urethanes (TPEUs). In some embodiments, the component monomers of the TPEUs are entirely derived from renewable sources. The disclosure also provides methods of making high-molecular-weight TPEUs, and, in particular, methods for achieving such high molecular weights. The disclosure also provides certain uses of such TPEUs. Entirely lipid-derived segmented thermoplastic TPEU elastomers with rubber-like properties such as low modulus and high elongation were produced by incorporating 1,9-nonanediol (ND) as chain extender with oleic acid derived polyester diols (PEDs) and 1,7-heptamethylene diisocyanate (HPMDI). Enhanced elastomeric properties were achieved by optimizing hydrogen bond density and phase separation of the TPEU via customized polymerization protocols. The novel TPEUs showed extensive degradation under hydrothermal ageing in water at 80° C. and achieved a tensile half-life in one day of immersion. For the first time, entirely lipid-derived TPEU elastomers with thermal and mechanical properties comparable to commercially available petroleum-based analogues and a controlled life-cycle were achieved, demonstrating the viability of potential alternatives to petroleum-derived elastomers and credible potential in biomedical applications especially as bio-resorbable implants or tissue scaffolds.

### CROSS-REFERENCE TO RELATED APPLICATIONS

The present application claims the benefit of priority from U.S. provisional application No. 62/259,771 filed on Nov. 25, 2015, the contents of which are incorporated herein by reference in their entirety.

### TECHNICAL FIELD

The disclosure generally provides high-molecular-weight thermoplastic polyester-based urethanes (TPEUs). In some embodiments, the component monomers of the TPEUs are entirely derived from renewable sources. The disclosure also provides methods of making high-molecular-weight TPEUs, and, in particular, methods for achieving such high molecular weights. The disclosure also provides certain uses of such TPEUs.

### DESCRIPTION OF RELATED ART

Segmented thermoplastic poly(ester urethane) (TPEU) elastomers are an interesting class of copolymers composed of a polyester macrodiol “soft segment” block and a “hard segment” block of urethane-rich segments formed by the reaction of a diisocyanate with a chain-extender diol. The polyester and urethane segments phase separate into nanoscale domains of crystalline “hard” segments which serve as a load bearing phase in the amorphous “soft” domains which provide extensibility. Segmented TPEUs are therefore two-phase polymers in contrast to one-phase polyurethanes synthesized without chain-extenders. TPEUs generally have excellent elastic properties and biocompatibility and generate a wide range of applications from wire and cable insulation jackets, automotive parts, footwear to biomedical devices where the hydrolytically labile polyester groups provide controlled degradation. Their chemical versatility allows for varying the type, ratio and processing conditions of starting components, to tailor the structure for customized applications.

Recently, the design of TPEU elastomers from vegetable oils have received much attention as potential substitutes that can compete with petroleum-based counterparts on a properties-function platform; with a positive environmental impact. However, the polyurethanes that are entirely derived from lipids so far presented low molecular weights and demonstrated inferior mechanical and elastic properties compared to those made partially from lipid—or fully from petroleum-based diols and diisocyanates. Also, the aliphatic fatty acid chains (12-22 carbons) of the triacylglycerol structure provide a shield for the ester groups, potentially delaying degradation.

Mechanical properties of high molecular weight polyurethane elastomers, associated with the hard and soft segment phase separation, have been shown to be a function of the monodisperse crystalline domains formed due to inter-segmental urethane-urethane hydrogen bonding. Moderate crystallinity arising from soft segments also introduces phase separation and reinforces mechanical strength. However, increased urethane-ester interaction, due to the presence of the proton acceptor carbonyl groups in polyester and urethane segments, increases phase mixing, adversely affecting tensile properties.

It has been shown through accelerated hydrothermal tests that hydrolytic ageing reduces molecular weight of TPEUs followed by the deterioration of mechanical and thermal properties. It has also been shown, in one embodiment, that aliphatic diisocyanates lack the cytotoxic degradation products associated with aromatic diisocyanate degradation and degrade into benign carboxylic acid by-products, especially useful for biomedical applications such as resorbable implants and scaffolds for tissue regeneration. Hydrolytic tests are sufficiently accelerated above 70° C. to allow for observable differences due to hydrolysis on structure and properties in a reasonable time, typically within 10-30 days. ASTM D3137 recommends a temperature of 85° C. for hydrolytic ageing tests. Tensile tests based on the modulus and elongation including the tensile half-life; which determines the time required for the tensile strength of the hydrolyzed polymer to reach half the tensile strength of the untreated polymer, have been widely used to rank the utility of hydrophilic polymers exposed to hydrolysis. Although these tests provide a measure of the macroscopic extent of polymer degradation, they do not inform on the pathways of degradation or the impact on the microstructure. Therefore, other methods such as ¹H-NMR, FTIR, GPC, SEM, TGA and DSC are concurrently necessary to determine the impact on microstructure.

Thus, there is a continuing need to develop new approaches to making TPEUs that can overcome one or more of the aforementioned problems.

### SUMMARY

In the present disclosure, entirely lipid-derived segmented TPEUs with enhanced elastomeric properties have been prepared by improving urethane-urethane hydrogen bonding and phase separation, by optimization of the structure and distribution of the urethane hard segments. The effect of chain extender and polymerization protocol on the solubility, phase separation, and thermal and mechanical properties of segmented elastomers were compared to the one-phase TPEU elastomer prepared previously by the one-shot method without using chain extender. The second objective was to subsequently investigate the effect of hydrothermal ageing on the structure and thermal and mechanical properties of these lipid-derived segmented and one-phase TPEU elastomers.

In some embodiments, entirely lipid-derived thermoplastic TPEU elastomers prepared from oleic acid based polyester diols PEDs, 1,7-heptamethylene diisocyanate (HPDMI) and 1,9-nonanediol (ND) as chain extender were prepared following two different protocols (described in more detail below). One difference in these protocols is the timing of the addition of the chain extender. In some embodiments, the chain extender is added in a second step, where it reacts with a diisocyanate-terminated poly(ester urethane) prepolymer. In this disclosure, the TPEUs made by that protocol are identified as “ND-A.” In some other embodiments, the chain extender is added in a first step, where it reacts with the diisocyanate monomer to form a polycarbamate prepolymer. In this disclosure, the TPEUs made by that protocol are identified as “ND-B.”

The TPEUs of the present disclosure can have certain beneficial properties. In some embodiments, the disclosure provides rubber-like elastomeric TPEUs with low initial modulus of 49 MPa and maximum strain of 440% superior to all other entirely lipid-derived segmented TPEUs previously reported. In some embodiments, the disclosure provides TPEUs having maximum strain superior to entirely lipid-derived one-phase TPEUs prepared without chain extenders. In some embodiments, the disclosure provides TPEUs having enhanced hydrogen bond density and phase separation achieved by the control of hard segment sequence length and distribution via the use of a chain extender and customized polymerization protocols. In some embodiments, the disclosure provides solvent-resistant TPEUs, not soluble at room temperature and insoluble or partially soluble at the solvent boiling point, in a large range of polarity solvents such chloroform, tetrahydrofuran (THF), dimethylformamide (DMF), N-methyl-pyrrollidone (NMP), dimethylimidazolidinone (DMI) and dimethysulfoxide (DMSO); solvents commonly used for processing polyurethanes. In some embodiments, the disclosure provides TPEUs having glass transition temperatures and mechanical properties comparable to commercially available entirely petroleum-derived TPEUs and partially lipid-derived TPEUs previously reported.

In some embodiments, the disclosure provides lipid-derived segmented TPEUs having certain desirable hydrothermal ageing characteristics. In some embodiments, the disclosure provides TPEUs having molecular weight degradation after 15 days of immersion in water at 80° C.—a drop from 85,000 g/mol at 15 days to 10,000 g/mol at 30 days. In some other embodiments, the disclosure provides TPEUs having mechanical properties that deteriorate under accelerated hydrothermal ageing conditions demonstrating a tensile half-life within 1 day of immersion, rendering the TPEUs unable to withstand any tensile loads.

In a first aspect, the disclosure provides polymer compositions, comprising one or more urethane polymers formed from a first reaction mixture, which comprises chain-extending monomers and diisocyanate-terminated poly(ester urethane) prepolymers; wherein the diisocyanate-terminated poly(ester urethane) prepolymers are formed from a second reaction mixture, which comprises C₂₋₄₀ diisocyanates and dihydroxyl-terminated polyesters; and wherein the dihydroxyl-terminated polyesters are formed from a third reaction mixture, which comprises C₉₋₂₂ diols and C₇₋₂₂ dicarboxylic acids or esters thereof.

In a second aspect, the disclosure provides polymer compositions, comprising one or more urethane polymers formed from a first reaction mixture, which comprises diisocyanate-terminated polycarbamate prepolymers and dihydroxyl-terminated polyesters; wherein the diisocyanate-terminated polycarbamate prepolymers are formed from a second reaction mixture, which comprises C₂₋₄₀ diisocyanates and chain-extending monomers; and wherein the dihydroxyl-terminated polyesters are formed from a third reaction mixture, which comprises C₉₋₂₂ diols and C₇₋₂₂ dicarboxylic acids or esters thereof.

Further aspects and embodiments are disclosed in the Detailed Description.

### BRIEF DESCRIPTION OF THE DRAWINGS

The following drawings are provided for purposes of illustrating various embodiments of the compounds, compositions, and methods disclosed herein. The drawings are provided for illustrative purposes only, and are not intended to describe any preferred compounds, preferred compositions, or preferred methods, or to serve as a source of any limitations on the scope of the claimed inventions.

FIG. 1 shows a synthetic scheme corresponding to certain embodiments of making poly (ester urethanes) disclosed herein. In one embodiment, two-stage pre-polymer synthesis of TPEU elastomers A) Pre-polymer method A, where ND (1,9 nonanediol) is added in step 2 of polymerization and B) pre-polymer method B, where ND is added in step 1 of pre-polymer formation.

FIG. 2 shows FTIR spectra of the carbonyl region of (a) ND-A, (b) ND-B and (c) PU2.1 (described in U.S. Provisional App. No. 62/259,754 filed Nov. 25, 2015). Dashed peaks are the deconvolution Gaussians obtained from of the baseline corrected C═O stretching bands. P1: free, P2: disordered hydrogen-bonded and P3: ordered hydrogen-bonded carbonyl groups. (d) Hydrogen bond index (R, •) and degree of phase separation (DPS, ∘)) of the TPEUs.

FIG. 3 shows SEM micrographs for the segmented TPEUs (a) ND-A and (b) ND-B and (c) PU2.1

FIG. 4 shows (a) Derivative TGA and (b) TGA curves for the segmented TPEUs ND-A and ND-B, and one-phase PU2.1 TPEU elastomers.

FIG. 5 shows DSC thermograms obtained during the second heating cycle (10° C./min) for the segmented ND-A and ND-B, and one-phase PU2.1 TPEU elastomers. Inset is a zoom into the glass transition of the TPEUs.

FIG. 6 are WAXD profiles of ND-A, ND-B and PU2.1, measured at room temperature, showing the indexed reflection planes corresponding to different crystalline forms. β′: Orthorhombic, M: Monoclinic.

FIG. 7 shows the viscoelastic properties of TPEUs (a) storage modulus and (b) loss modulus versus temperature curves of ND-A, ND-B and PU2.1 (described in U.S. Provisional App. No. 62/259,754, filed Nov. 25, 2015).

FIG. 8 shows stress-strain curves for segmented ND-A and ND-B, and one-phase PU2.1 TPEU elastomers.

FIG. 9 shows the GPC curves for the hydrolysis of (a) PU2.1 and (b) ND-B. S₁: Peak associated with larger molecular weight species; S₂: Peak associated with the smaller molecular weight species.

FIG. 10 shows the evolution of (a) the number average molecular weight (Mₙ), (b) Dispersity ( [symbol] ), and (c) percentage loss of sample weight and molecular weight (Mₙ) with immersion time for PU2.1 and ND-B. Curved lines in panels (a) and (b) are fits to the exponential decay function and in panel (c) are guides for the eye.

FIG. 11 shows possible chemical structures and ¹H-NMR spectra for the degradation products of (a) PU2.1 and (b) ND-B

FIG. 12 shows the Deconvolution into Gaussians of the hydrogen-bonded carbonyl spectral region of the FTIR of (a) PU2.1 and (b) ND-B before and after 30 days of hydrolysis at 80° C.

FIG. 13 shows hydrogen bonding index (R, •) and degree of phase separation (DPS, ∘) of (a) one-phase PU2.1 and (b) segmented ND-B TPEU elastomers due to hydrolysis.

FIG. 14 shows the SEM micrographs of pristine and after 30 days hydrothermal ageing of (a) one-phase PU2.1 and (b) two-phase ND-B.

FIG. 15 shows DSC thermograms for the accelerated hydrolytic ageing of (a) one-phase PU2.1 and (b) segmented ND-B TPEU elastomers at various immersion times.

FIG. 16 shows DSC data obtained from the second heating cycle for the one-phase PU2.1 (▴) and segmented ND-B (•) elastomers at various immersion times. (a) Moisture content (b) Enthalpies of melt (c) Peak temperature of P2 and (d) degree of crystallinity of P2. In (a) the dashed lines are fits of the data to a sigmoidal function (R2>0.9877) and a linear function (R2>0.9601). Dashed lines in (b) and (c) and (d) are guides for the eye.

FIG. 17 shows stress-strain curves for hydrolyzed (a) one-phase PU2.1 and (b) segmented ND-B elastomers. The extraction time is reported on each curve.

FIG. 18 shows the (a) Ultimate tensile strength, (b) Young's modulus and (c) maximum strain of TPEU elastomers versus immersion time. The dashed lines are guides for the eye.

FIG. 19 shows derivative TGA curves measured at various immersion times for the hydrolytically aged (a) one-phase PU2.1 and (b) segmented ND-B.

FIG. 20 shows relative decomposition of urethane and ester groups with immersion time.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### DEFINITIONS

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “reaction” and “reacting” refer to the conversion of a substance into a product, irrespective of reagents or mechanisms involved.

As used herein, “polymer” refers to a substance having a chemical structure that includes the multiple repetition of constitutional units formed from substances of comparatively low relative molecular mass relative to the molecular mass of the polymer. The term “polymer” includes soluble and/or fusible molecules having chains of repeat units, and also includes insoluble and infusible networks.

As used herein, “prepolymer” refers to a polymer that can undergo further reaction to contribute constitutional units to the chemical structure of a different polymer.

As used herein, “monomer” refers to a substance that can undergo a polymerization reaction to contribute constitutional units to the chemical structure of a polymer.

As used herein, “polyurethane” refers to a polymer comprising two or more urethane (or carbamate) linkages. Other types of linkages can be included, however. For example, in some instances, the polyurethane or polycarbamate can contain urea linkages, formed, for example, when two isocyanate groups can react. In some other instances, a urea or urethane group can further react to form further groups, including, but not limited to, an allophanate group, a biuret group, or a cyclic isocyanurate group. In some embodiments, at least 70%, or at least 80%, or at least 90%, or at least 95% of the linkages in the polyurethane or polycarbamate are urethane linkages. Such “polyurethanes” can include polyurethane block copolymers, which refers to a block copolymer, where one or more of the blocks are a polyurethane or a polycarbamate. Other blocks in the “polyurethane block copolymer” may contain few, if any, urethane linkages. For example, in some polyurethane block copolymers, at least one of the blocks is a polyether or a polyester and one or more other blocks are polyurethanes or polycarbamates.

As used herein, “polyester” refers to a polymer comprising two or more ester linkages. Other types of linkages can be included, however. In some embodiments, at least 80%, or at least 90%, or at least 95% of the linkages in the polyester are ester linkages. The term can refer to an entire polymer molecule, or can also refer to a particular polymer sequence, such as a block within a block copolymer. The term “dihydroxyl polyester” refers to a polyester having two or more free hydroxyl groups, e.g., at the terminal (e.g., reacting) ends of the polymer (i.e., a “dihydroxyl-terminated polyester”). In some embodiments, such polyesters have exactly two free hydroxyl groups.

As used herein, “alcohol” or “alcohols” refer to compounds having the general formula: R—OH, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “alcohol” or “alcohols” may refer to a group of compounds with the general formula described above, wherein the compounds have different carbon lengths. The term “hydroxyl” refers to a —OH moiety. In some cases, an alcohol can have more than two or more hydroxyl groups. As used herein, “diol” and “polyol” refer to alcohols having two or more hydroxyl groups.

As used herein, “amine” or “amines” refer to compounds having the general formula: R—NH₂, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “amine” or “amines” may refer to a group of compounds with the general formula described above, wherein the compounds have different carbon lengths. The term “amino” refers to a —NH₂ moiety. In some cases, an amine can have two or more amino groups. As used herein, “diamine” and “polyamine” refer to amines having two or more amino groups.

As used herein, “isocyanate” or “isocyanates” refer to compounds having the general formula: R—NCO, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “isocyanate” or “isocyanates” may refer to a group of compounds with the general formula described above, wherein the compounds have different carbon lengths. The term “isocyanato” refers to a —NCO moiety. In some cases, an isocyanate can have more than two or more isocyanato groups. As used herein, “diisocyanate” and “polyisocyanate” refer to isocyanates having two or more isocyanato groups.

As used herein, “carboxylic acid” or “carboxylic acids” refer to compounds having the general formula: R—CO₂H, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “carboxylic acid” or “carboxylic acids” may refer to a group of compounds with the general formula described above, wherein the compounds have different carbon lengths. The term “carboxyl” refers to a —CO₂H moiety. In some cases, an isocyanate can have more than two or more carboxy groups. As used herein, “dicarboxylic acid” and “polycarboxylic acid” refer to carboxylic acids having two or more carboxyl groups.

The terms “group” or “moiety” refers to a linked collection of atoms or a single atom within a molecular entity, where a molecular entity is any constitutionally or isotopically distinct atom, molecule, ion, ion pair, radical, radical ion, complex, conformer etc., identifiable as a separately distinguishable entity.

As used herein, “mix” or “mixed” or “mixture” refers broadly to any combining of two or more compositions. The two or more compositions need not have the same physical state; thus, solids can be “mixed” with liquids, e.g., to form a slurry, suspension, or solution. Further, these terms do not require any degree of homogeneity or uniformity of composition. This, such “mixtures” can be homogeneous or heterogeneous, or can be uniform or non-uniform. Further, the terms do not require the use of any particular equipment to carry out the mixing, such as an industrial mixer.

As used herein, the term “natural oil” or “lipid” refers to oils derived from various plants or animal sources. These terms include natural oil derivatives, unless otherwise indicated. The terms also include modified plant or animal sources (e.g., genetically modified plant or animal sources), unless indicated otherwise. Examples of natural oils include, but are not limited to, vegetable oils, algae oils, fish oils, animal fats, tall oils, derivatives of these oils, combinations of any of these oils, and the like. Representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil. Representative non-limiting examples of animal fats include lard, tallow, poultry fat, yellow grease, and fish oil. Tall oils are by-products of wood pulp manufacture. In some embodiments, the natural oil or natural oil feedstock comprises one or more unsaturated glycerides (e.g., unsaturated triglycerides).

As used herein, “natural oil derivatives” refers to the compounds or mixtures of compounds derived from a natural oil using any one or combination of methods known in the art. Such methods include but are not limited to saponification, fat splitting, transesterification, esterification, hydrogenation (partial, selective, or full), isomerization, oxidation, and reduction. Representative non-limiting examples of natural oil derivatives include gums, phospholipids, soapstock, acidulated soapstock, distillate or distillate sludge, fatty acids and fatty acid alkyl ester (e.g. non-limiting examples such as 2-ethylhexyl ester), hydroxy substituted variations thereof of the natural oil. For example, the natural oil derivative may be a fatty acid methyl ester (“FAME”) derived from the glyceride of the natural oil.

As used herein, “alkyl” refers to a straight or branched chain saturated hydrocarbon having 1 to 30 carbon atoms, which may be optionally substituted, as herein further described, with multiple degrees of substitution being allowed. Examples of “alkyl,” as used herein, include, but are not limited to, methyl, ethyl, n-propyl, isopropyl, isobutyl, n-butyl, sec-butyl, tert-butyl, isopentyl, n-pentyl, neopentyl, n-hexyl, and 2-ethylhexyl.

For any compound, group, or moiety, the number carbon atoms in that compound, group, or moiety is represented by the phrase “C_{x-y}” which refers to an such a compound, group, or moiety, as defined, containing from x to y, inclusive, carbon atoms. Thus, “C₁₋₆alkyl” refers to an alkyl chain having from 1 to 6 carbon atoms.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A1 and A2, then one or more members of the class can be present concurrently.

As used herein, the various functional groups represented will be understood to have a point of attachment at the functional group having the hyphen or dash (-) or an asterisk (*). In other words, in the case of —CH₂CH₂CH₃, it will be understood that the point of attachment is the CH₂ group at the far left. If a group is recited without an asterisk or a dash, then the attachment point is indicated by the plain and ordinary meaning of the recited group.

In some instances herein, organic compounds are described using the “line structure” methodology, where chemical bonds are indicated by a line, where the carbon atoms are not expressly labeled, and where the hydrogen atoms covalently bound to carbon (or the C—H bonds) are not shown at all. For example, by that convention, the formula

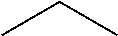

represents n-propane.

As used herein, multi-atom bivalent species are to be read from left to right. For example, if the specification or claims recite A-D-E and D is defined as —OC(O)—, the resulting group with D replaced is: A-OC(O)-E and not A-C(O)O-E.

Unless a chemical structure expressly describes a carbon atom as having a particular stereochemical configuration, the structure is intended to cover compounds where such a stereocenter has an R or an S configuration.

Other terms are defined in other portions of this description, even though not included in this subsection.

### TPEU Compositions

In a first aspect, the disclosure provides polymer compositions, comprising one or more urethane polymers formed from a first reaction mixture, which comprises chain-extending monomers and diisocyanate-terminated poly(ester urethane) prepolymers; wherein the diisocyanate-terminated poly(ester urethane) prepolymers are formed from a second reaction mixture, which comprises C₂₋₄₀ diisocyanates and dihydroxyl-terminated polyesters; and wherein the dihydroxyl-terminated polyesters are formed from a third reaction mixture, which comprises C₉₋₂₂ diols and C₇₋₂₂ dicarboxylic acids or esters thereof.

The denotation of the “first,” “second,” and “third” reaction mixture does not imply any ordering of steps, but merely distinguishes the two reaction mixtures from each other.

Any suitable chain-extending monomers can be used. In some embodiments, the chain-extending monomers comprise diols, diamines, or combinations thereof. In some embodiments, the chain-extending monomers comprise C₉₋₂₂ diols, C₉₋₂₀diols, or C₉₋₁₈diols, or C₉₋₁₆diols. In some embodiments, the chain-extending monomers are 1,9-nonanediol.

Any suitable C₂₋₄₀ diisocyanates can be used in the above embodiments. In some such embodiments, the C₂₋₄₀ diisocyanates are C₂₋₃₀diisocyanates, or C₃₋₂₀diisocyanates, or C₄₋₁₅ diisocyanates, or C₅₋₁₀diisocyanates. In some such embodiments, the C₂₋₄₀ diisocyanates are 1,7-heptamethylene diisocyanate.

Any suitable C₉₋₂₂ diols can be used to make the polyester in any of the above embodiments. In some such embodiments, the C₉₋₂₂ diols are C₉₋₂₀diols, or C₉₋₁₈ diols, or C₉₋₁₆ diols. In some embodiments, the C₉₋₂₂ diols are 1,9-nonanediol. Further, any suitable C₇₋₂₂ dicarboxylic acids or esters thereof (e.g., C₁₋₆ alkyl esters, such as methyl esters) can be used to make the polyester in any of the above embodiments. In some such embodiments, the C₇₋₂₂ dicarboxylic acids or esters thereof are C₇₋₂₀dicarboxylic acids, or C₇₋₁₈dicarboxylic acids, C₇₋₁₆dicarboxylic acids, or esters of thereof. In some such embodiments, the C₇₋₂₂ dicarboxylic acids or esters thereof are azelaic acid or esters thereof.

The dihydroxyl-terminated polyesters used in any of the above embodiments can have any suitable properties. In some such embodiments, the dihydroxyl-terminated polyesters have a number-average molecular weight (Mₙ) of at least 3000 g/mol, or at least 3500 g/mol, or at least 4000 g/mol, or at least 4500 g/mol. In some such embodiments, the dihydroxyl-terminated polyesters have a polydispersity index ranging from 1 to 2.

In some embodiments, it may be desirable to make the polyester from renewable materials. Thus, in some embodiments, the dihydroxyl-terminated polyesters are formed from lipid-derived monomers. In some such embodiments, the dihydroxyl-terminated polyesters have a renewable carbon content of at least 80%, or at least 85%, or at least 90%, or at least 95%, or at least 97%, or at least 98%, or at least 99%. In some such embodiments, the dihydroxyl-terminated polyesters have a renewable carbon content of 100%.

The polymer compositions of the foregoing embodiments can have any suitable physical properties. In some embodiments, the polymer composition exhibits one or more of the following properties: an initial modulus ranging from 46 MPa to 147 MPa; an ultimate tensile strength ranging from 7.7 MPa to 14.7 MPa; or an ultimate elongation at break ranging from 195% to 492%. In some embodiments, the polymer compositions comprise urethane polymers having a hard segment (the polycarbamate segment) and a soft segment (the polyester segment), wherein the hard segment exhibits one or more of the following properties: an onset of melting temperature of about 60° C.; an offset temperature of about 107° C.; or a peak melting temperature ranging from 84° C. to 88° C. In some further such embodiments, the soft segment exhibits one or more of the following properties: an onset of melting temperature ranging from −11.5° C. to −8.9° C.; an offset temperature of about 50° C.; a peak melting temperature of about 32° C.; or a glass transition temperature ranging from −35° C. to −23° C. In some such embodiments, the soft segment exhibits an enthalpy of melting ranging from 26.0 J/g to 30.7 J/g. In some such embodiments, the hard segment exhibits an enthalpy of melting ranging from 11.5 J/g to 19.8 J/g. In some embodiments, the polymer composition exhibits a degree of crystallinity ranging from 18% to 44%. In some such embodiments, the polymer composition exhibits one or more of the following properties: an onset temperature of thermal decomposition at 5% weight loss of about 259° C.; a peak decomposition temperature of about 292° C. for the hard segment; a peak decomposition temperature of about 392° C. for the soft segment; or a pyrolysis temperature of about 450° C. As used herein, the term “about” encompasses the range of error in making the measurement, which, in some embodiments is within ±3° C.

In some embodiments, it can be desirable that the dihydroxyl-terminated polyesters have certain properties. In some embodiments, the dihydroxyl-terminated polyesters exhibit one or more of the following properties: an onset temperature of thermal decomposition at 5% weight loss of about 214° C.; a peak decomposition temperature of about 412° C.; or a pyrolysis temperature of about 457° C.

In some embodiments of any of the aforementioned embodiments, the polymer composition can have certain desirable degradation characteristics. Thus, in some embodiments, upon immersing the one or more polymers in water at 80° C. for 30 days, the one or more polymers degrade into one or more hydrolyzed products, the one or more hydrolyzed products having a weight-average molecular weight (M_{w}) of no more than 4000 g/mol. In some embodiments, the polymer composition exhibits one or more of the following properties: an increased enthalpy of melting ranging from 26.3 J/g to 77.4 J/g following immersion of the polymer composition in water for 5 days at 80° C.; or a decreased enthalpy of about 28 J/g following immersion of the polymer composition in water for 20 days at 80° C. In some embodiments, the polymer composition undergoes tensile failure in no more than 10 days of immersion in water at 80° C. In some embodiments, the polymer composition reaches its tensile half-life in no more than one day upon immersion in water at 80° C.

In other aspects, the disclosure provides polymer compositions, comprising one or more urethane polymers formed from a first reaction mixture, which comprises diisocyanate-terminated poly(ester urethane) prepolymers and dihydroxyl-terminated polyesters; wherein the diisocyanate-terminated poly(ester urethane) prepolymers are formed from a second reaction mixture, which comprises C₂₋₄₀ diisocyanates and chain-extending monomers; and wherein the dihydroxyl-terminated polyesters are formed from a third reaction mixture, which comprises C₉₋₂₂ diols and C₇₋₂₂ dicarboxylic acids or esters thereof.

The denotation of the “first,” “second,” and “third” reaction mixture does not imply any ordering of steps, but merely distinguishes the three different reaction mixtures from each other.

Any suitable chain-extending monomers can be used. In some embodiments, the chain-extending monomers comprise diols, diamines, or combinations thereof. In some embodiments, the chain-extending monomers comprise C₉₋₂₂ diols, C₉₋₂₀ diols, or C₉₋₁₈ diols, or C₉₋₁₆ diols. In some embodiments, the chain-extending monomers are 1,9-nonanediol.

Any suitable C₂₋₄₀ diisocyanates can be used in the above embodiments. In some such embodiments, the C₂₋₄₀ diisocyanates are C₂₋₃₀diisocyanates, or C₃₋₂₀diisocyanates, or C₄₋₁₅diisocyanates, or C₅₋₁₀diisocyanates. In some such embodiments, the C₂₋₄₀ diisocyanates are 1,7-heptamethylene diisocyanate.

Any suitable C₉₋₂₂ diols can be used to make the polyester in any of the above embodiments. In some such embodiments, the C₉₋₂₂ diols are C₉₋₂₀diols, or C₉₋₁₈diols, or C₉₋₁₆diols. In some embodiments, the C₉₋₂₂ diols are 1,9-nonanediol. Further, any suitable C₇₋₂₂ dicarboxylic acids or esters thereof (e.g., C₁₋₆ alkyl esters, such as methyl esters) can be used to make the polyester in any of the above embodiments. In some such embodiments, the C₇₋₂₂ dicarboxylic acids or esters thereof are C₇₋₂₀ dicarboxylic acids, or C₇₋₁₈ dicarboxylic acids, C₇₋₁₆ dicarboxylic acids, or esters of thereof. In some such embodiments, the C₇₋₂₂ dicarboxylic acids or esters thereof are azelaic acid or esters thereof.

The dihydroxyl-terminated polyesters used in any of the above embodiments can have any suitable properties. In some such embodiments, the dihydroxyl-terminated polyesters have a number-average molecular weight (Mₙ) of at least 3000 g/mol, or at least 3500 g/mol, or at least 4000 g/mol, or at least 4500 g/mol. In some such embodiments, the dihydroxyl-terminated polyesters have a polydispersity index ranging from 1 to 2.

In some embodiments, it may be desirable to make the polyester from renewable materials. Thus, in some embodiments, the dihydroxyl-terminated polyesters are formed from lipid-derived monomers. In some such embodiments, the dihydroxyl-terminated polyesters have a renewable carbon content of at least 80%, or at least 85%, or at least 90%, or at least 95%, or at least 97%, or at least 98%, or at least 99%. In some such embodiments, the dihydroxyl-terminated polyesters have a renewable carbon content of 100%.

The TPEUs disclosed herein can be synthesized by any suitable means, although some means may be more desirable than others. Suitable synthetic methodologies are disclosed in the Examples, below. The claims to the compounds, or to compositions including the compounds, are not limited in any way by the synthetic method used to make the compounds.

### Examples

The following examples are provided to illustrate one or more preferred embodiments of the invention. Numerous variations can be made to the following examples that lie within the scope of the claimed inventions.

### Experimental

### Materials

Stannous octoate (Sn(Oct)₂) (98%), dibutylamine (98%), 1,9-nonanediol (98%), calcium hydride (98%), anhydrous tetrahydrofuran (THF), calcium hydride (98%), N-methyl-2-pyrrolidone (NMP), 1, 3 dimethyl-2-imidazolidinone (DMI), dimethyl sulfoxide (DMSO) and diethyl ether were purchased from Sigma Aldrich (Oakville, Ontario), Canada. Chloroform (CHCl₃), methanol and dimethyl formamide (DMF) were obtained from ACP Chemical Int. (Montreal, Quebec), Canada. Clear glass laboratory bottles, 60 mL, with polyethylene cone-lined caps were purchased from Fisher Scientific (Whitby, Ontario). All reagents except DMF and THF were used as obtained. DMF was dried overnight over calcium hydride followed by vacuum distillation (˜300 Torr). THF was distilled after drying overnight over 4 A molecular sieves. PEDs of molecular weight 2000 g/mol were synthesized from oleic acid-derived azelaic acid and 1, 9 nonanediol as described in Shetranjiwalla et al., Polymer, vol 92, pp 140-152 (2016) 1,7-Heptamethylene diisocyanate (97%, 180 g/mol) was also synthesized from azelaic acid disclosed in in Hojabri et al., Biomacromolecules, vol. 10, pp. 884-891 (2009).

### Synthesis

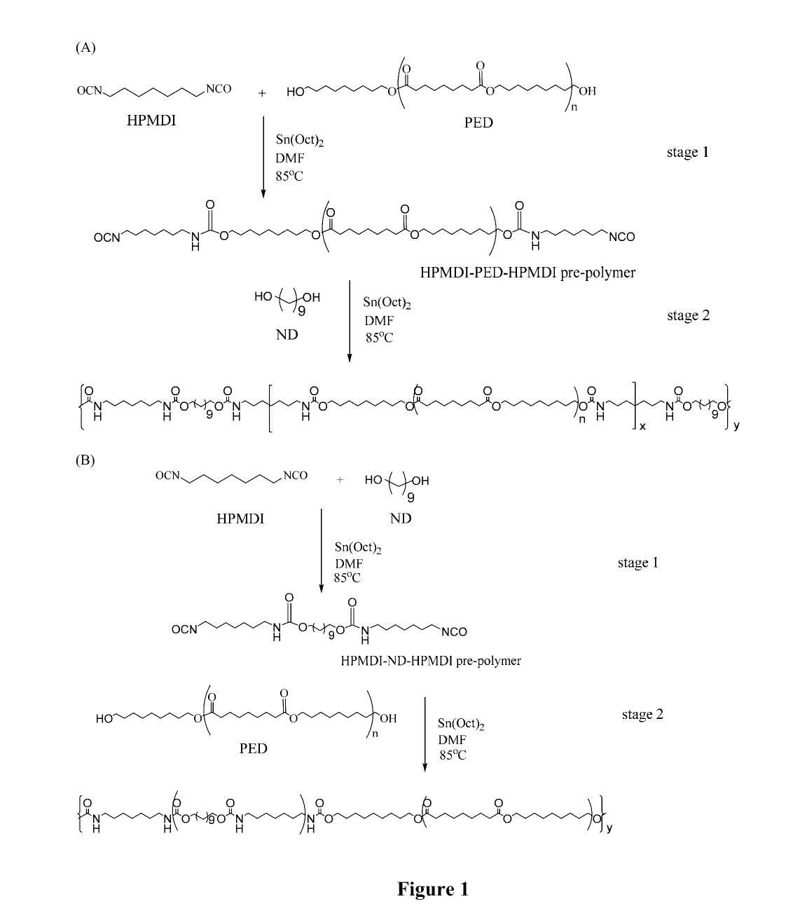

The segmented TPEU elastomers were synthesized by reacting molecular weight controlled PEDs and HPMDI with 1,9-nonanediol (ND) in the presence of Sn(Oct)₂ using the two stage pre-polymer polymerization method; pre-polymer method A, where ND is added in step 2 of polymerization and pre-polymer method B where ND is added in step 1 of the polymerization, which is illustrated in FIG. 1. The overall NCO:OH ratio was fixed at 1:1 and TPEUs were polymerized for 24 h. The polymerization recipes of methods A and B are presented in Table 1.

In Table 1, the nomenclature, recipe for the polymerization and the yield (%) of the TPEUs is shown. The ratios of HPMDI (1,7 heptamethylene diisocyanate), ND (1,9 nonanediol) as chain extender and PED (polyester diol) used in the synthesis are molar.

TABLE 1

| Polymerization | | Step 1 | | | Step 2 | | |
|---|---|---|---|---|---|---|---|
| Method | TPEU | HPMDI | ND | PED | ND | PED | Yield |
| A | ND-A | 2.1 | 0 | 1.5 | 0.6 | 0 | 75 |
| B | ND-B | 2.1 | 0.6 | 0 | 0 | 1.5 | 80 |
| One-shot | PU2.1 | 2.1 | — | 1 | — | — | 82 |

In the pre-polymer method A, excess HPMDI (0.63 g, 3.5 mmol) was dissolved in 6.3 mL of DMF in a round bottom flask attached to a thermometer and stirred under an inert atmosphere. The PED (1.65 g, 0.09 mmol) and catalyst Sn(Oct)₂ (0.07 g, 0.17 mmol) were dissolved in 16.5 mL of DMF and then added to HPMDI through an addition funnel. The reaction was constantly stirred (600 rpm) at 85° C. for 5 h. In the second step, ND diol (1.7 mmol) and catalyst (0.0064 g) was dissolved in 1.7 mL of DMF and added to the HPMDI-PED-HPMDI pre-polymer (FIG. 1A). The reaction was continued at 85° C. for another 19 h under inert conditions with constant stirring at 400 rpm.

The pre-polymer method B differed from method A only in the sequence of addition of reactants. In pre-polymer method B, excess HPMDI (0.63 g, 3.5 mmol) was dissolved in 6.3 mL of DMF and stirred at 85° C. In the first step, ND diol (1.7 mmol) and catalyst (0.0064 g), dissolved in 1.7 mL of DMF was added to HPMDI from a dropping funnel under constant stirring and reacted for 5 h. In the second step, PED (1.65 g, 0.09 mmol) and catalyst Sn(Oct)₂ (0.07 g, 0.17 mmol) dissolved in 16.5 mL of DMF, was added to the -HPMDI-ND-HPMDI- pre-polymers (FIG. 1B). The reaction was continued for another 19 hours under inert conditions with constant stirring at 400 rpm. The reaction products from both methods were precipitated from excess water and dried under vacuum until constant weight. The dry polymers were purified by soaking in chloroform (10 mL/g) for one hour and washing with excess methanol. The polymers were coded based on the sequence of addition of the chain extender, ND, during polymerization. ND-A represents the segmented TPEU synthesized by pre-polymer method A where 1,9-nonanediol (ND) was added afterwards in step 2 during polymerization, whereas ND-B represents the segmented TPEU synthesized via the pre-polymer method B where ND was added before in Step 1 of the pre-polymer formation (Table 1). Dried samples were melt-pressed into films. The solubility of the polymers was tested in various solvents with different polarities viz. CHCl₃, THF, DMF, NMP, DMI and DMSO. The structure was examined by FTIR and the thermal and mechanical properties were analyzed by DSC, TGA and tensile tests and compared with the one-phase TPEU coded PU2.1 synthesized without chain extender as shown in Table 1.

### Sample Preparation and Hydrothermal Testing

Samples of entirely lipid-derived one-phase (PU2.1) and segmented (ND-B) elastomer films were immersed in 25 mL deionized water of pH 7.12 in sealed laboratory bottles that were placed in an oven at a temperature of 80±5° C. following a previously reported in Pretsch et al., Polymer Degradation and Stability, vol. 94(1), pp. 61-73 (2009) and Muller et al., Eu. Polymer Journal, vol. 46(8), pp. 1745-1758 (2010). Accelerated hydrolytic ageing was carried out for 30 days and ageing was tested on samples at 1 day (1 d), 5, 10, 15, 20, 25 and 30 d. Prior to DSC, TGA and tensile measurements the samples were taken out of the laboratory bottles and allowed to cool down to room temperature and dried with lint-free paper. FTIR samples were dried under vacuum at room temperature until constant weight prior to analysis.

For DSC studies, square samples between 5 and 6 mg were cut from the films. For TGA analysis rectangular samples weighing approximately 10 mg were used. For FTIR studies the samples were approximately 20 mg rectangles of thickness 0.64±0.1 mm. Dumb-bell shaped films of thickness 0.60±0.25 mm were used for tensile measurements.

### Characterization Techniques

Solubility tests were conducted on TPEU samples after they were purified and dried under vacuum until constant weight. Tests were performed for all samples in CHCl₃, THF, DMF; NMP, DMI and DMSO, solvents with different polarities as indicated by their different dielectric constants, commonly used for processing polyurethanes. The sample (1 mg of TPEU in 1 mL of solvent) was stirred for thirty (30) minutes and left in the solvent for 2 days. The sample was then brought to the boiling point of the solvent at least three times for at least five (5) minutes each. In DMF, samples were refluxed for fifteen (15) minutes.

Scanning Electron Microscopy (SEM) was performed on a Phenom ProX apparatus (Phenom-World, The Netherlands) at an accelerating voltage of 15 kV and map intensity. Uncoated thin rectangular samples were fixed to the char reduction sample holder with conductive tape. Composite images were captured using the Automated Image Mapping software (Phenom-World, The Netherlands).

Fourier transform infrared spectroscopy (FTIR) was performed on a Thermo Scientific Nicolet 380 FTIR spectrometer (Thermo Electron Scientific Instruments, LLC, USA) equipped with a PIKE MIRacle attenuated total reflectance (ATR) system (PIKE Technologies, Madison, Wis., USA.). The sample was placed onto the ATR crystal area and held in place by the pressure arm. The spectrum was acquired in the 400-4000 cm⁻¹ scanning range using 64 scans at a resolution of 4 wavenumbers. All spectra were recorded at ambient temperature.

The carbonyl hydrogen bonding index (R) which provides a measure of the increasing participation of the carbonyl groups in hydrogen bonding was determined as a ratio of the intensities of the normalized hydrogen-bonded (˜1714 cm⁻¹ and ˜1690 cm⁻¹) and the free (˜1731 cm⁻¹) carbonyl stretching peaks. The 1780 cm⁻¹ to 1660 cm⁻¹ region was fitted with three Gaussians after baseline correction using OriginPro (version 9.2, 2015) software. The three Gaussians correspond to free carbonyl groups and hydrogen-bonded disordered and ordered carbonyl groups. The residual values for all Gaussian peak fits were better than 2 percent.

Proton Nuclear Magnetic Resonance (¹H-NMR) spectra were recorded on a Bruker Advance III 400 spectrometer (BrukerBioSpin Mill GmbH, Karlsruhe, Germany) at a frequency of 400 MHz using a 5-mm BBO probe. The spectra were acquired at 25° C. over a 16-ppm window with a 1-s recycle delay, 32 transients. Spectra were Fourier transformed, phase corrected, and baseline corrected. Chemical shifts were referenced relative to the residual solvent peak (CDCl₃, δ(¹H)=7.26 ppm).

Degradation products were evaluated by ¹H-NMR. The water in which the samples were hydrothermally aged was collected and dried completely. The residual products were dissolved in CDCl₃.

Thermogravimetric analysis (TGA) was carried out on a Q500 TGA model (TA instrument, Newcastle, Del., USA), under dry nitrogen of 40 mL/min (balance purge flow) and 60 mL/min (sample purge flow). Approximately 9.0-10.0 mg of sample was loaded in an open TGA platinum pan that was equilibrated at 25° C. and heated to 600° C. at 10° C./min.

Films for tensile and dynamical mechanical analysis (DMA) testing were prepared on a Carver 12-ton hydraulic heated bench press (Model 3851-0- Wabash, Ind., USA). The dry samples were melt pressed at 150° C. and cooled at a controlled rate of 5° C./min. The mechanical properties of the TPEU films were measured at room temperature (RT=23° C.) by uniaxial tensile testing using a texture analyzer (Texture Technologies Corp, NJ, USA) equipped with a 2-kg load cell following the ASTM D882 procedure. The sample was stretched at a rate of 5 mm/min from a gauge of 35 mm at room temperature. The reported results are the average from at least four specimens.

DMA was performed on a Q800 model DMA (TA Instruments, New Castle, DA) equipped with a liquid nitrogen cooling system. The measurements were performed on rectangular samples (17.5 mm×10 mm×0.6 mm) under the flexural oscillation mode following ASTM E1640 standard. The frequency and amplitude were fixed at 1 Hz and 15 μm, respectively. The sample was equilibrated −90° C. for 5 min then heated at 2° C./min to 40° C. The data was analyzed with TA Instruments Universal Analysis 2000 software.

Wide-angle x-ray diffraction (WAXD) measurements were performed on a PANalytical EMPYREAN diffractometer (PANalytical B.V, Lelyweg, The Netherlands) equipped with a filtered CuKα (λ=1.540598 Å) radiation source and PIXcel^{3D} detector used in line-scanning mode. The XRD patterns were recorded between 3 and 50° (2θ) in 0.026 steps. The procedure was automated and controlled by PANalytical Data Collector (V 3.0c) software. The data analysis was carried out using PANalytical's X'Pert High Score 3.0.4 software. The percentage degree of crystallinity (X_{C}) was estimated according to equation 3.

$${X}_{C} = 100 * \frac{{A}_{C}}{{A}_{C} + {A}_{A}} \qquad ( 3 )$$

Where A_{C} is the area under the crystal diffraction peaks and A_{A} is the area under the amorphous halo. The amorphous contribution was fitted with two lines centered at 4.0 Å and 4.7 Å as usually done for semi-crystalline polymers [21, 22].

The relative crystallinity of the hydrolyzed TPEU (X_{C}) was calculated as the ratio of its melting enthalpy) to the melting enthalpy of the pristine TPEU (ΔHₘ⁰); equation 4:

$${x}_{c} = \frac{Δ {H}_{m}}{Δ {H}_{m}^{0}} \qquad ( 4 )$$

Differential Scanning calorimetry (DSC) measurements were carried out on Q200 model (TA instrument, Newcastle, Del., USA) under a dry nitrogen gas atmosphere following the ASTM D3418 standard. The sample (5.0-6.0 mg±0.6 mg), contained in a hermetically sealed aluminum pan, was first heated (referred to as the 1st heating cycle), to 180° C. and held at that temperature for 5 min to erase thermal history, and then cooled to −80° C. at 5° C./min. The sample was subsequently heated to 180° C. (referred to as the 2nd heating cycle) at 10° C./min. During the second heating cycle measurements were performed in the modulation mode with modulation amplitude of 1° C./min and period of 60 s.

DSC measurements on one-phase and segmented TPEU elastomer samples after hydrothermal ageing were also carried out under an inert N₂ atmosphere. Samples contained in a hermetically sealed aluminum pan, were first cooled to −60° C. at 5° C./min and then heated to 90° C. for the one-phase TPEUs and 110° C. for the segmented TPEUs at 10° C./min, modulation amplitude of 1° C./min and a modulation period of 60 s. The sample was held at that temperature for 5 min and then cooled to −80° C. at 5° C./min.

Gel Permeation Chromatography (GPC) tests were carried out on the hydrolytically aged TPEU elastomer samples on a Waters Alliance e2695 separation module (Milford, Mass., USA), equipped with a Waters 2414 refractive index detector and a high resolution Styragel HRSE column (5 μm). Chloroform was used as the eluent with a flow rate of 0.5 mL/min. Detector and column temperatures were 40° C. and 43° C., respectively. The concentration of the sample was 1 mg/mL and the injection volume was 30 μL. Polystyrene standards (molecular weight range between 1.2×10³ Da and 133×10³ Da) were used to calibrate the curve.

The weight loss of the hydrothermally treated samples was determined by drying the remaining aged sample under vacuum until constant weight (W₁) and comparing it to the original weight (W₀) of the sample as a percentage; equation 4

$$W = \frac{{W}_{1}}{{W}_{0}} x 100 \qquad ( 5 )$$

### Results and Discussion

### Effect of Polymerization Protocol on Structure

The segmented TPEUs tested in a range of solvents with increasing polarity, as indicated by their increasing dielectric constants were insoluble at room temperature. At solvent boiling point, ND-B was insoluble in all solvents, whereas ND-A showed partial solubility in DMF and DMSO. The partial solubility of ND-A in DMF and DMSO is attributed to possibly a lower molecular weight as compared to ND-B and the one-phase TPEU PU2.1 (Table 2). These results are of practical importance for TPEU applications requiring high solvent-resistance. Table 2 shows the solubility results and the polarities of the solvents used in the experiment as indicated by their dielectric constants.

TABLE 2

| Solvent | ε | ND-A | ND-B | PU2.1 |
|---|---|---|---|---|
| CHCl₃ | 4.85 | I | I | I |
| THF | 7.52 | I | I | I |
| NMP | 32.00 | I | I | I |
| DMI | 37.60 | I | I | I |
| DMF | 38.25 | PS | I | I |
| DMSO | 47.00 | PS | I | I |

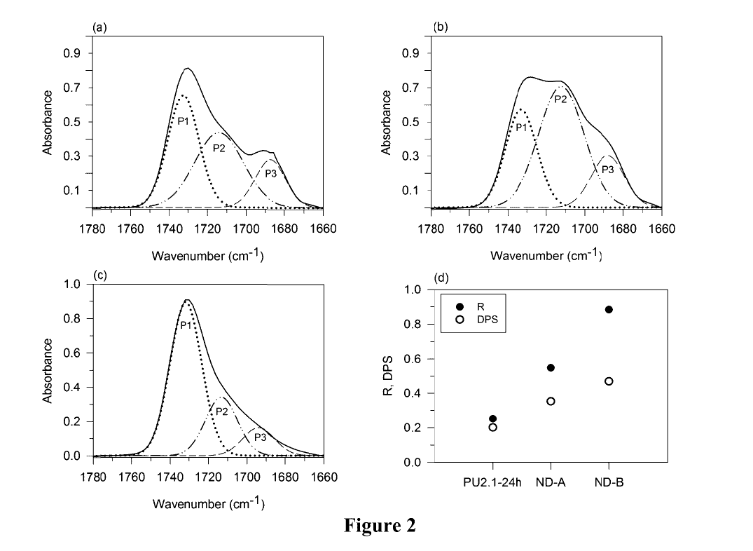

The solubility data were explained by the variation in hydrogen bonding of the TPEUs as estimated from the analysis of the C═O region (1660-1780 cm⁻¹) of their FTIR spectra. FIG. 2 shows the results of peak fitting of the 1660-1780 cm⁻¹ region of the FTIR for ND-A and ND-B. The peak fitting analysis for PU2.1 is also shown for comparison in FIG. 2. The carbonyl hydrogen bonding index (R) which provides a measure of the increasing participation of the carbonyl groups in hydrogen bonding, and the degree of phase separation (DPS) which provides the measure of urethane-urethane interaction are also presented in FIG. 2.

As evident from FIG. 2a-c, the ratio of the intensity of disordered (P2) and the ordered (P3) hydrogen bonding peaks to the peak of free C═O (P1) is the largest in ND-B segmented TPEU followed by ND-A and PU2.1, indicating that the polymerization protocol B provided the maximum hydrogen bond density, followed by the polymerization protocol A and then the one-shot method. The variation of R and DPS values (filled and empty circles in FIG. 2d, respectively) indicates an increase of the inter-urethane hydrogen bonding and suggests the improvement of phase separation from PU2.1 to ND-A and ND-B. The very low DPS value of PU2.1 indicates a high phase mixing associated with a random dispersion of urethane segments in the polyester matrix. Contrary to the aromatic diisocyanates, there is no electronegativity effect for the linear aliphatic HPMDI of the present work. If any, steric effect will also be negligible.

The rate of reaction is rather governed by proximity effects arising from the molecular size of the diisocyanate terminated pre-polymers known to impact accessibility of the isocyanate groups for subsequent reaction. The different molecular sizes of the pre-polymers of ND-A and ND-B, pre-designed in the first stage of polymerization, result in the different reactivity in the following second stage and the subsequent difference in molecular weight and yield. The better reactivity of ND-B and subsequent better polymer yield after precipitation compared to ND-A is attributable to a more favorable spatial distance between the two isocyanate groups in the HPMDI-ND-HPMDI pre-polymers of ND-B compared to the HPMDI-PED-HPMDI pre-polymer of ND-A (a minimum of 43 carbons versus 25 carbons). Moreover, during the polymerization of ND-A, the concentration of the more reactive HPMDI monomer available to react with ND was lower in stage two. Also, the concentration of available HPMDI was probably further reduced by the potential organotin catalyst-mediated fragmentation of the PED, upsetting the overall NCO:OH stoichiometric imbalance in this stage and affecting the subsequent reaction with ND. This may explain the lower yield after precipitation (Table 1) and the lower molecular weight of ND-A compared to ND-B for which the concentration of the monomer diisocyanate available to react with PED in the second step was higher. Furthermore, because the chain extender was sandwiched between diisocyanate segments, a larger sequence length of the urethane hard segment is formed in ND-B (repeating unit x, FIG. 1B). This promotes greater intermolecular hydrogen bonding between neighboring urethane segments and results in a narrowly distributed hard segment structure and improved phase separation. In contrast, a major portion of the diisocyanate in ND-A is sandwiched between two flexible PED chains (repeating unit x in FIG. 1A) and is considered to be a part of the soft segment, where it is more likely to participate in urethane-ester hydrogen bonding leading to increased phase mixing.

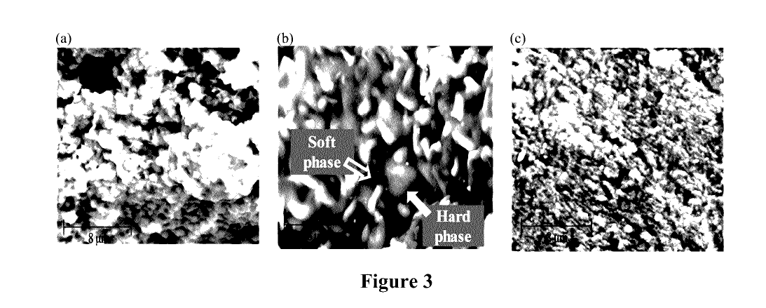

FIGS. 3a-c show the SEM images of, ND-A, ND-B and PU2.1, respectively. As shown in FIGS. 3a and b, the surface morphology of the segmented TPEUs is constituted of protuberances (pointed to by a filled arrow in FIG. 3b) separated by trough-like regions (pointed to by an empty arrow in FIG. 3b) indicating a two-phase system. The prominent regions in the SEM images of FIG. 3 indicate microstructures which are normally associated with the self-assembly of hydrogen bonded urethane hard phase; whereas, the trough-like regions are associated with the amorphous polyester chains and constitute the soft phase.

The average size of the microstructures increased from ˜0.7±0.2 μm for PU2.1, to 1.2±0.2 μm for ND-A and 2.3±0.7 μm for ND-B indicating an increase in urethane hard segment content and hydrogen bond density. ND-B showed much larger microstructures (FIG. 3b) than ND-A (FIG. 3a) indicating a larger size of the hydrogen bonded urethane phase. In contrast, PU2.1 displayed a wrinkled surface morphology (FIG. 3c) with much smaller microstructures, a morphology commonly associated with the predominance of an amorphous phase. The microstructures of PU2.1 show that the hard domains are dispersed in the soft matrix and reflects the FTIR results, which indicated the lowest DPS. One can note that the trough-like regions formed by amorphous polyester chains between the urethane microstructures are deepest in ND-B indicating an improved interconnectedness and a distinct phase separation. Comparatively, SEM of ND-A showed much smaller microstructures indicative of less developed urethane hard segment domains. The surface morphology of ND-A is indicative of a higher phase mixing which is the direct result of the polymerization protocol (Method A, FIG. 1A). The SEM data show that urethane hard segment domains and phase separation were promoted by the addition of the chain extender and further by the polymerization protocol.

### Effect of Polymerization Protocol on the Thermal Behavior

Thermal Stability

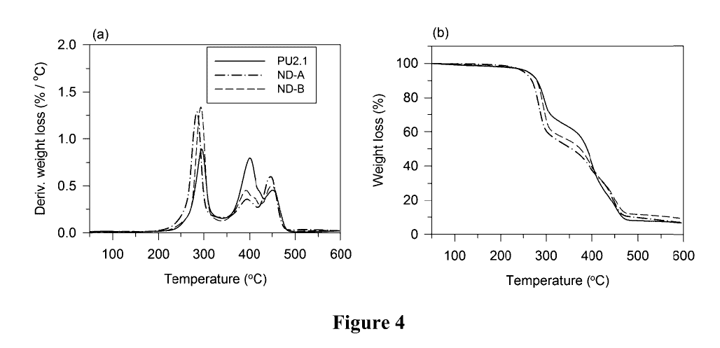

FIG. 4 a and b show the DTG and TGA profiles for the segmented and one-phase TPEUs respectively. The corresponding onset temperatures of decomposition, T_{d(on)}, determined at 5.0% weight loss, DTG peak temperatures (T_{d}) and weight loss obtained for each decomposition stage (ΔW) were recorded.

The series of weight loss steps corresponding to the decomposition the C—NH (280-300° C.), C—O (390-400° C.) and the C—C bonds (450° C.) are distinctly indicated by their characteristic temperature ranges. It is evident from the DTG peaks of FIG. 4a that the segmented TPEUs had a larger urethane content than PU2.1 based on the percentage weight loss for urethane and ester decomposition. This is in accordance with the weight percent ratios employed in the formulation of the TPEUs where the amount of HPMDI (24.6%) used in the segmented TPEUs was almost 1.5 times that of the amount used for the one-phase TPEU 17.2%). Onsets of degradation at 5% for ND-A and ND-B polymers are identical (FIG. 4b) at 259° C. indicating that the thermal stability of the segmented TPEUs is independent of molecular weight and extent of phase separation.

The higher thermal stability of the one-phase PU2.1 compared to the segmented TPEUs ND-A and ND-B, is attributable to various factors such as potentially higher molecular weight, higher polyester soft segment content, or increased resistance to thermal scission of the crystalline polyethylene-like linear chain stacking.

Melt Transition and Crystallization Behavior

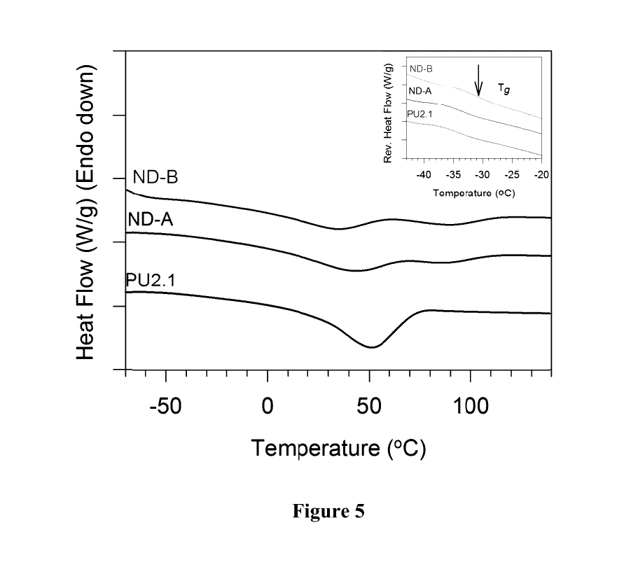

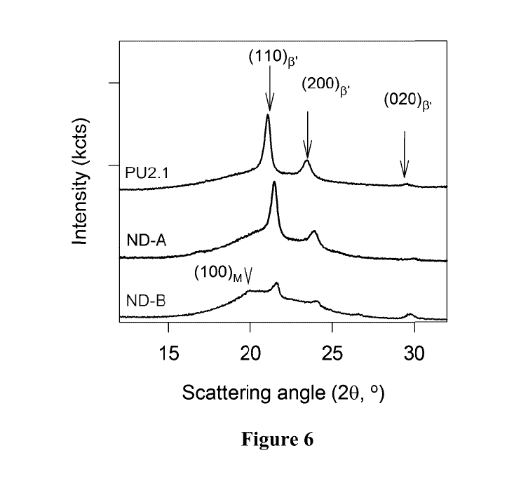

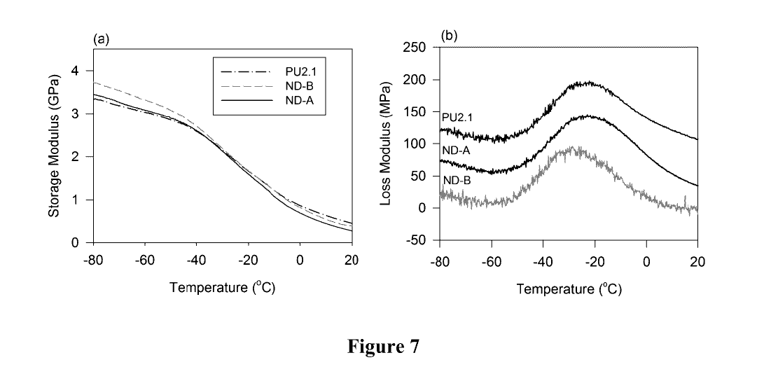

FIG. 5 shows the second heating DSC thermograms of ND-A and ND-B. The curve for one-phase TPEU elastomer PU2.1 is presented for comparison purposes. The corresponding melting parameters and glass transition temperatures are summarized in Table 3.

The distinct phase separation of the urethane hard segments and the polyester soft segments for segmented TPEUs was confirmed by the DSC thermograms in FIG. 5. Two distinct melting transitions are visible, attributed to the melting of the soft (˜32° C.) and the hard segment crystallites (˜84° C.). The above characteristics are in contrast to those of the one-phase TPEU which showed a unique endotherm at an intermediate temperature (˜50° C.), indicative of the melting of soft segment crystallites of a co-continuous phase.

Table 3 shows thermal data obtained during the second heating cycle (10° C./min) of the segmented TPEUs. Tₘ(° C.) and ΔH (J/g): melting and enthalpy of melting, respectively. T_{g} (° C.): glass transition temperature obtained at ^{a}10° C./min and ^{b}20° C./min. The uncertainties attached to the characteristic temperatures and enthalpies are better than 2.5° C. and 2.8 J/g, respectively.

TABLE 3

| | Soft Segment | | | | | | Hard Segment | | | |
|---|---|---|---|---|---|---|---|---|---|---|
| TPEUs | Tₒₙ | T_{off} | Tₘ | ΔH | T_{g}^{a} | T_{g}^{b} | Tₒₙ | T_{off} | Tₘ | ΔH |
| ND-A | −9.2 | 49.4 | 40.2 | 29.5 | −38.0 | −34.6 | 59.9 | 105.6 | 84.3 | 14.0 |
| ND-B | −9.5 | 49.6 | 32.4 | 27.0 | −34.7 | −30.0 | 60.2 | 106.7 | 87.2 | 16.4 |
| PU2.1 | 31.3 | 63.1 | 50.3 | 51.2 | −39.9 | −35.6 | — | — | — | — |

The effect of phase separation was reflected in a decreased onset (Tₒₙ), peak (Tₘ) temperatures and enthalpy (ΔH) of melting of the soft segments suggesting that less stable and less organized soft segment crystallites were formed in ND-A and ND-B compared to PU2.1. This is indicative of increased polyester soft segment block length due to improved phase separation. The higher Tₒₙ, Tₘ and ΔH in PU2.1 is attributed to the stabilizing influence of the phase-mixed urethane segments in the polyester soft segment domain.

The improved degree of phase separation in the segmented TPEUs ND-A and ND-B was reflected in the decreased peak temperatures (Tₘ) and enthalpy (ΔH) of melting of the soft segments compared to the melting of the co-continuous phase of PU2.1. This is explained by the increased phase separation of the polyester segments from the hydrogen-bonded urethane segments, and the resulting weaker attractions (van der Waals forces) in the soft segments of the segmented TPEUs as compared to the one-phase PU2.1. The melting parameters are lower in ND-B than ND-A, indicating that a better separation of the soft segment phase from the hard segment phase occurs in ND-B. PU2.1 exhibits a higher Tₘ and ΔH, attributable to its phase-mixed nature of urethane segments in the larger polyester matrix (83% versus 75% in ND-A and ND-B).

The melting data of the hydrogen-bonded urethane segments can be related to the extent of the hard segment distribution in the segmented TPEU. The lower enthalpy of ND-A hard segment crystallites compared to ND-B indicates a lower crystallinity ascribed to a lower hard segment hydrogen bond density. ND-A presented a lower value of Tₘ than ND-B indicating smaller urethane hard segment domains. ND-A and PU2.1 which share a similar structure of their amorphous soft segments, corresponding to the one-shot and polymerization protocol A followed, also show similar glass transition temperatures (T_{g}). ND-B exhibited the highest T_{g} attributed to the maximum restriction imposed on the soft segment chain mobility by the larger hard segment domains.

### Effect of Polymerization Protocol on Mechanical Properties

### Tensile Properties

The stress-strain curves for the segmented TPEUs ND-A and ND-B are shown in FIG. 7. The stress-strain curve of the one-phase TPEU PU2.1 is provided for comparison purposes. The relevant tensile properties are listed in Table 4.

The TPEUs ND-A and ND-B shown in FIG. 7 exhibit stress-strain curves typical of rubber-like materials displaying low modulus and no apparent yield point characteristic of polymers with high phase separation. In contrast, PU2.1 displayed yielding followed by a drop in stress indicative of semi-crystalline materials where deformation energy is dissipated through elongation of entangled chains rather than by transfer to the stress-bearing crystalline hard segments. ND-A and ND-B showed lower tensile strength and modulus compared to PU2.1 attributed to their lower polyester segment crystallinity. ND-A showed the least tensile strength and strain corresponding to its lower molecular weight. ND-B displayed the highest elongation (440%±52%) attributed to its better phase separation as confirmed by FTIR in FIG. 2. This indicated that well-developed reinforcing crystalline phase structures provided effective stress bearing junctures. ND-B also showed the low modulus characteristic of elastomers attributed to its highly flexible and phase separated polyester segments and low crystallinity.

The higher tensile strength and modulus of PU2.1 compared to ND-A and ND-B is the result of its much higher polyester crystallinity. Also, for aliphatic TPEUs with low hard segment content, the amorphous segments orient and crystallize under strain, acting as a stress bearing phase which further increase the tensile strength. Correspondingly, a linear trend for Young's modulus versus degree of crystallinity has been observed in linear polyethylene. PU2.1 also exhibited high strain attributed to the strain hardening typical of elastomers which is also visible in ND-B.

The strength and extensibility values for the entirely lipid-derived segmented TPEUs of the present disclosure approach those of the closest analogue of ultra-high molecular weight partially lipid-derived TPEUs from HPMDI, ND and petroleum-based PEAD (PLD in Table 3) synthesized by Li et al., Polymer, 2014, 55(26), 6764-6775) and also commercially available polyester grade thermoplastic elastomers synthesized from aliphatic diisocyanates (PGTE 1 and 2 in Table 4). The mechanical properties of the segmented TPEUs of this study are superior to the entirely lipid-derived TPUs synthesized from HPMDI, ND and oleic acid derived polyester diol, 18-octadec-9-endiol (ELD in Table 3).

Table 4 shows mechanical properties of TPEUs derived from tensile analysis. The uncertainties attached to Young's modulus, ultimate tensile strength, and elongation at break are the standard deviations of at least four runs and are better than 31.5 MPa, 1.9 MPa and 51.6% respectively. Polyester grade thermoplastic (PGTE) synthesized from aliphatic diisocyanates. PGTE1: PEARLCOAT Activa D198K and PGTE2: PEARLTHANE D91F88 (Merquinza).

TABLE 3

| | Young's | Ultimate | Maximum strain |
|---|---|---|---|
| TPEUs | modulus (MPa) | strength (MPa) | (%) |
| ND-A | 123.6 | 8.4 | 236.5 |
| ND-B | 49.4 | 14.2 | 440.0 |
| PU2.1 | 253.5 | 18.2 | 353.4 |
| ELD | — | 21.0 | 39.0 |
| PLD | 83.0 | 22.8 | 543.0 |
| PGTE1 | — | 25.0 | 455.0 |
| PGTE2 | — | 23.0 | 388.0 |

### Dynamic and Static Mechanical Properties

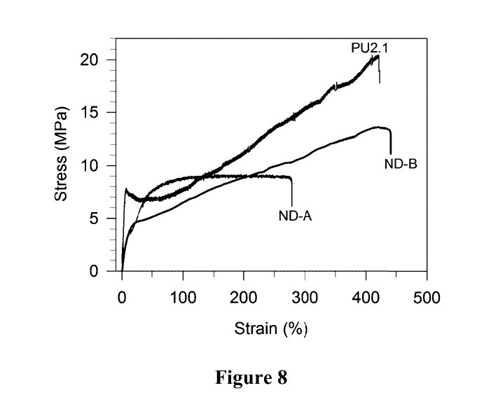

FIGS. 8a and 8b show the storage and loss modulus versus temperature curves, respectively, of ND-A, ND-B and PU2.1. The storage modulus recorded in the glassy region was highest for ND-B (3.87±0.60 GPa) followed by ND-A (3.70±0.04 GPa) than PU2.1 (3.52±0.08) as one would expect from their decreasing hard segment content and associated hydrogen bonding density (R, in FIG. 2d). In the rubbery and leathery regions, the storage modulus decreased consistent with their soft segment crystallinity level. PU2.1 shows a slightly higher retention of stored energy than ND-B and ND-A, attributed to the presence of urethane segments in the polyester soft segment matrix, i.e. high phase mixing (lowest DPS, FIG. 2). A single loss modulus peak was detected below room temperature for PU2.1, ND-A and ND-B attributed to the glass transition of the amorphous units of the TPEU soft segments. No glass transition was detected for the hard segments.

The glass transition (T_{g}) as determined at the peak maximum of the loss modulus curve and was −25.1±0.7° C. for PU2.1, a value that is close to that for ND-A (−23.2±0.2° C.) indicating very close amorphous phase structures attributable to the one-shot method and the pre-polymers of the Protocol A. The much lower T_{g} of ND-B (−28.7±1.2° C.) can be ascribed to its more pronounced phase separation and greater purity of its polyester soft segments associated with the polymerization protocol B. The T_{g} for ND-B is the lowest by DMA in contrast to the T_{g} seen by DSC as a result of the difference in the sample processing for the two techniques. An extensive demixing of the hard and soft segments is observed during melt-processing for film formation for DMA analysis which enhances phase separation between hard and soft segments.

### Hydrolytic Degradation Results for TPEU Elastomers

Structural Changes Due to Hydrothermal Ageing

The entirely lipid-derived segmented TPEUs ND-A and ND-B synthesized in this study differed in their structure and morphology from the one-phase PU2.1 elastomer. Therefore, it was expected that the response of the segmented and one-phase elastomers to hydrothermal ageing would be a function of their structures. ND-B was selected for hydrothermal analysis and comparison with the one-phase PU2.1 because it exhibited higher phase separation and better mechanical properties than ND-A.

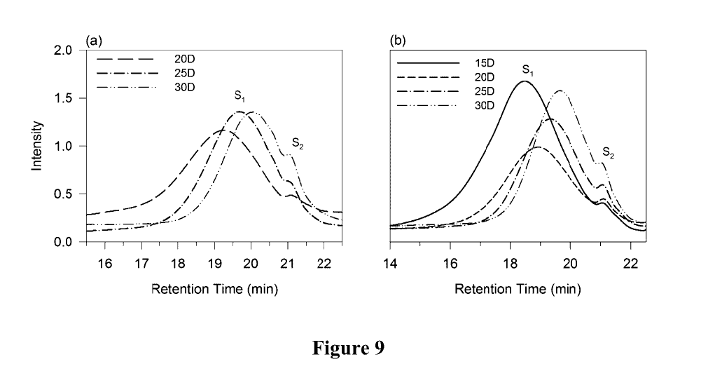

The solubility, molecular weight and dispersity ( [symbol] ) of PU2.1 and ND-B are provided in Table 5. FIG. 9 shows the GPC curves for their molecular weight distribution. As indicated in Table 5, ND-B and PU2.1 were soluble after 15 and 20 days of hydrolytic ageing respectively, suggesting that due to hydrolysis, there was a weakening of the polyethylene-like linear chain conformation of the TPEUs and the formation of smaller molecular weight species, which promoted dissolution. The formation of smaller molecular weight species due to the fragmentation of the larger chains is indicated by the bimodal distribution of the GPC curves in FIG. 9. Peak S₂ associated with the smaller fragments and cyclic oligomers is observed at higher retention time compared to the peak S₁ associated with the larger molecular weight species. It is of note that S₁ consistently shifted to a higher retention time for both ND-B and PU2.1-24 h, indicating that there was a continuous decrease in molecular weight of the polymers with increasing immersion time after 15 and 20 days, respectively, as shown by the declining values of Mₙ and M_{w} in Table 5.

Table 5 shows the solubility and GPC data of PU2.1 and ND-B after accelerated hydrolytic degradation. tᵢ: Immersion time (days), M_{w}: weight average molecular weight (gmol⁻¹), Mₙ: number average molecular weight (gmol⁻¹), [symbol] : Dispersity. Uncertainty on M_{w}, Mₙ and D are better than 3000 gmol⁻¹, 418 gma⁻¹ and 0.34, respectively.

TABLE 5

| PU2.1 | | | | | ND-B | | | |
|---|---|---|---|---|---|---|---|---|
| tᵢ | | Mₙ | M_{w} | [symbol] | | Mₙ | M_{w} | [symbol] |
| 0 | Insoluble | | — | | Insoluble | | — | |
| 5 | Insoluble | | — | | Insoluble | | — | |
| 10 | Insoluble | | — | | Insoluble | | — | |
| 15 | Insoluble | | — | | Soluble | 11514 | 85005 | 7.39 |
| 20 | Soluble | 6654 | 21419 | 3.22 | Soluble | 7471 | 24829 | 3.32 |
| 25 | Soluble | 4369 | 9239 | 2.11 | Soluble | 5643 | 15282 | 2.71 |
| 30 | Soluble | 3308 | 5668 | 1.72 | Soluble | 4330 | 10414 | 2.40 |

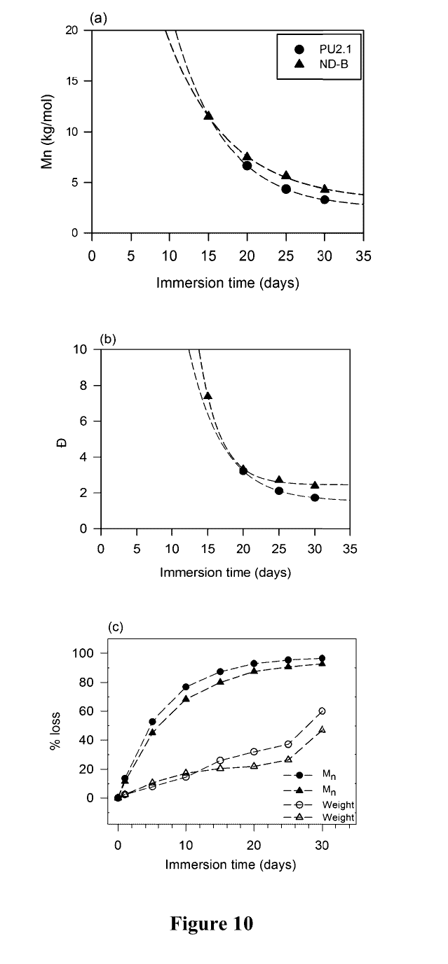

The molecular weight and [symbol] of both TPEUs decreased rapidly with immersion time (FIG. 10a-b, respectively). The rate of decrease for PU2.1 was much higher than for ND-B because of its higher polyester content which is hydrolyzed an order of a magnitude faster than the urethane segments. A fit to an exponential decay function of Mₙ versus immersion time curves (R²>0.9988) suggests that initially PU2.1 had a much larger Mₙ (extrapolated at 95 kgmol⁻¹) than ND-B (extrapolated at 60 kgmol⁻¹). This may explain the relatively high mechanical performance of PU2.1 compared to ND-B despite its one-phase morphology. The D of both TPEUs decreased with increasing immersion time also in an exponential manner, again at a higher rate for PU2.1. This is attributed to the bulk scission of the longest polymer chains forming shorter chains which can readily diffuse out of the material resulting in the homogenization of the polymer.

FIG. 10c shows the losses in Mₙ and the remaining sample weight. The percentage loss in Mₙ until 15 days for ND-B and 20 days for PU2.1 has been estimated from the extrapolated curve fits in FIG. 10a. A rapid decrease in Mₙ was noted for ND-B and PU2.1 during the 30 days of hydrolysis reaching 93% and 97% of the estimated original molecular weight. In contrast, the weight loss for ND-B and PU2.1 remained lower at 48% and 60%, respectively, indicating that despite the extensive cleavage of polymer chains, the fragments did not completely diffuse out of the matrix or did not reach a molecular weight below a critical value to form soluble oligomers. Until 10 days ND-B showed a relatively larger decrease in sample weight than PU2.1. This trend was reversed after 15 days and weight loss rapidly increased in PU2.1 after 20 days and was higher than ND-B at 30 days. This is attributed to the difference in the composition and phase structure of the two polymers.

ND-B which is a two-phase TPEU, has a well separated amorphous soft segment domain and low crystallinity. Water is easily diffused in the amorphous region leading to hydrolysis and some early erosion of the polymer. The production of carboxylic acid from the degradation of polyester segments as a result of hydrolysis can be related to the decrease in pH of the immersion water (from 7.4 to 4.5) observed between 5 and 10 days of accelerated degradation (Table 6). However, with increasing immersion time, weight loss recedes as water encounters the well-developed, degradation-resistant hard segment domains. In contrast, PU2.1 showed a lower initial weight loss attributed to the relatively inhibited access of water in the polymer due its higher crystallinity and also the embedded nature of the urethane segments in the soft segment domains which mitigate early erosion of the degradation products. This may explain the retention of neutral pH of the immersion water at 10 days (Table 6). However, PU2.1 recorded increased weight loss and a sharp drop in pH at 20 days, indicating a rapid deterioration of the polyester-rich matrix due to the accelerated penetration of water with increasing immersion time (after 10 days, FIG. 10c). At 30 days, the pH rose from 7.4 to 9.7 in ND-B and PU2.1, suggesting that there was release of amine degradation products into the immersion water as a result of the hydrolysis of urethane bonds as water diffused into the hard segments of TPEUs. The increased weight loss at 30 days for the polymers encompassed the erosion of both the soft and hard segments. Table 2 shows the pH changes of the immersion water.

TABLE 6

| | |
|---|---|
| Immersion | |
| time | pH |

| (days) | PU2.1 | ND-B |
|---|---|---|
| 0 D | 7.37 ± 0.03 | 7.37 ± 0.03 |
| 5 D | 7.57 ± 0.07 | 4.55 ± 0.02 |
| 10 D | 7.03 ± 0.05 | 4.52 ± 0.01 |
| 20 D | 5.92 ± 0.02 | 6.86 ± 0.06 |
| 30 D | 9.67 ± 0.02 | 9.77 ± 0.01 |

### Analysis of Degradation Products

On hydrolysis, the polyester segments of TPEUs mainly decompose into starting diols and dicarboxylic acids, which further decompose to carbon dioxide and water. The urethane bonds also co-hydrolyze under high humidity, producing carbamic acid, which further reduces to amines and carbon dioxide.

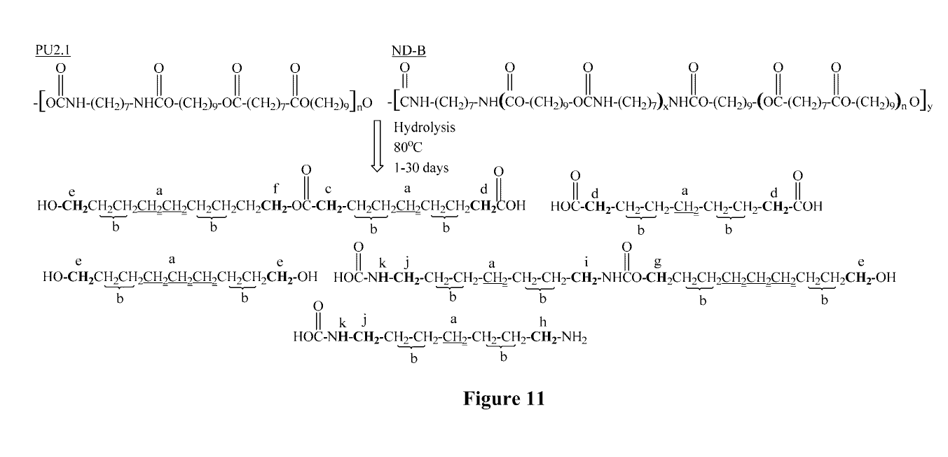

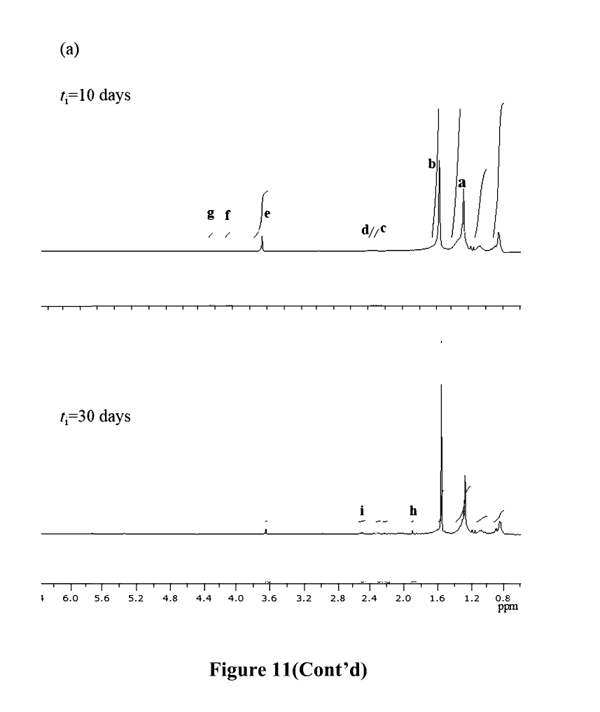

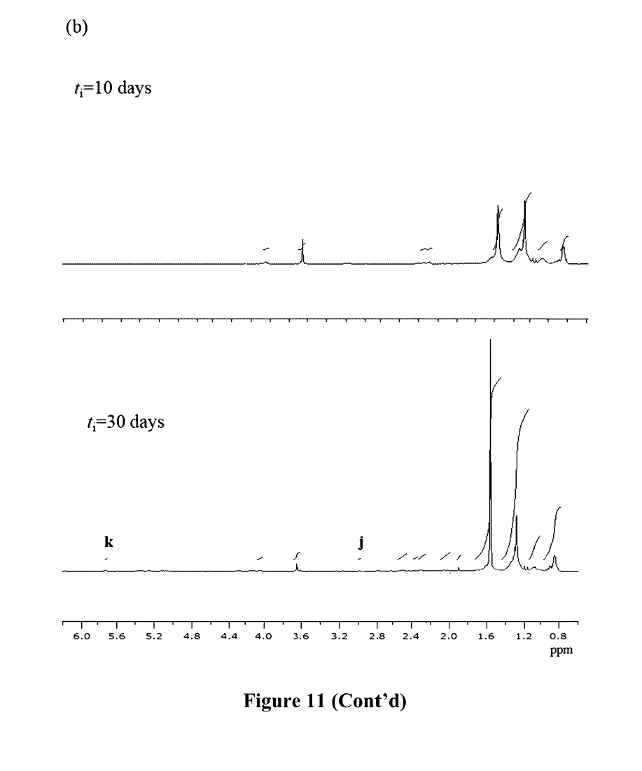

The ¹H-NMR spectra and the possible chemical structures for the degradation products of PU2.1 and ND-B after 10 days and 30 days of hydrolysis are shown in FIG. 11 (a-b). Chemical shifts for the peaks associated with the oligomers of polyester diols (PED)s and polyurethane were observed at 1.26 ppm (CH₂CH₂CH₂CH₂O, CH₂CH₂CH₂CH₂C═O, and CH₂CH₂CH₂CH₂NHC═O, peak a) and 1.54 ppm (CH₂CH₂CH₂CH₂O, CH₂CH₂CH₂CH₂C═O, and CH₂CH₂CH₂CH₂NHC═O, peak b) in both polymers after 10 and/or 30 days of hydrolysis. Chemical shifts associated with the methylene protons adjacent to the ester group in the PEDs at 2.25-2.27 ppm (CH₂C═O, peak c) and 4.02-4.04 ppm (CH₂O, peak f) were also observed. This indicated that, on hydrolysis, the TPEUs formed fragments of molecular weight low enough to form soluble oligomers. This was confirmed by the loss in weight of the remaining sample (empty symbols in FIG. 10c). Methylene protons in the alpha position to alcohol groups (CH₂OH, peak e) and the carbonyl of the carboxylic acid group (CH₂C(O)OH) were detected at 3.64-3.66 ppm and 2.33-2.35 ppm respectively, indicating that starting diols and diacids were present in the degradation products. Chemical shifts detected upheld between 0.85 and 1.09 ppm are attributed to the methylene protons on the backbone of cyclic oligomers which are known to form at elevated temperatures in dimeric or larger difunctional chains by intramolecular cyclization.

Interestingly, the intensity of all peaks reduced from tᵢ=10 days to tᵢ=30 days for both polymers indicating that the TPEU molecular size was significantly deteriorated at this time. Also, new peaks at chemical shifts 1.89-191 ppm and 2.46-2.53 ppm were detected attributed to the methylene protons attached to the nitrogen in the amine (CH₂NH₂, peak h) and the carbamate groups (CH₂NHC(O)O, peak i), respectively. The appearance of these peaks indicates the presence of degradation products associated with the hydrolysis of urethane bonds in the immersion water, as also seen by the rise in pH at 30 days. Moreover, at 30 days, ND-B which has a higher urethane content than PU2.1 shows two additional low-intensity peaks at 2.95-2.97 ppm and 5.73 ppm associated with urethane degradation, attributed to the methylene protons attached to the nitrogen of the carbamic acid group (CH₂NHC(O)OH, peak j) and the proton attached to the nitrogen of the carbamic acid group (HNC(O)OH) respectively.

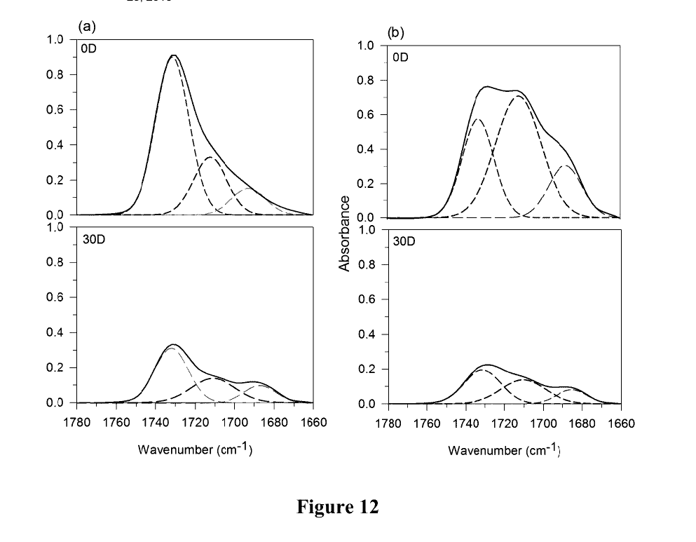

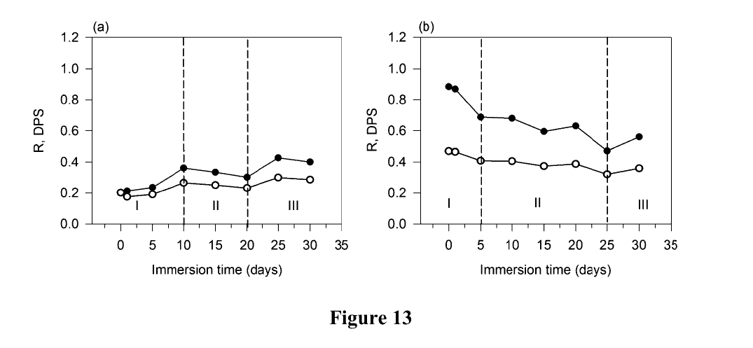

Aged samples of PU2.1 and ND-B extracted at selected immersion times were dried and analyzed with FTIR. The deconvolution of the FTIR 1780-1660 cm⁻¹ spectral region of PU2.1 and ND-B into its free (˜1732 cm⁻¹), disordered (˜1715 cm⁻¹) and ordered (˜1690 cm⁻¹) hydrogen-bonded carbonyl peaks are provided in FIG. 12. The resulting hydrogen bonding index, R and associated DPS versus immersion time curves are shown in FIGS. 13a and b, respectively. Their analysis indicated three stages in the evolution of the hydrogen bonding index, R, and associated DPS (regions I, II and III in FIGS. 13a and b). The actual mechanisms at play in the three stages depended on the type of TPEU phase structure and on the relative effect of hydrolysis on the hard and soft segments.

The first stage in the hydrolysis of PU2.1 (0-10 days, stage I in FIG. 13a) where a significant increase of R and DPS (filled and empty circles in FIGS. 13a and b respectively) was observed is attributed to a hydrolysis-induced reorganization of polyester segment chains and the formation of new hydrogen bonds with hard segments dispersed in the polyester soft segment domain. It can also be inferred from the increase of R and DPS during this stage that the number of hydrolytically disrupted bonds exceed the re-esterified linkages only slightly. As suggested for polyamides, water molecules are probably first integrated as bridges between N—H and C═O groups or between two carbonyl groups which increases the concentration of the hydrogen-bond density resulting in further phase separation and stabilization of the hard segment structures.

The second stage (10-20 days) manifested with a gradual drop in R and DPS (stage II in FIG. 13a). During this step, the urethane segments are further dispersed in the polyester matrix by diffused water, disrupting the hydrogen bonding and gradually reducing the concentration of hydrogen-bonded carbonyl groups. In the third stage (stage III in FIG. 13a) a rapid loss of mass of the polyester segments results in the increase of the relative concentration of un-degraded urethane segments and hence in R and DPS. But as evident at 30 days, R decreases again after the hydrogen bonding in the small residual hard segment domain start to degrade.

The drop in R in phase I in ND-B (0-5 days, region I in FIG. 13b) is explained by its high phase separation which allows more easily water to diffuse into the hard and soft segments reducing the concentration of hydrogen-bonded carbonyl groups at an early stage in the hydrolysis process. The hydrogen bonding index continues to gradually decline in phase II (5-25 days), due to the hydrolysis of the urethane and polyester segments and subsequent increase in the degree of phase mixing. In a the third and final stage (>25 days, Region III in FIG. 13b) R increases as the concentration of degradation-resistant urethane hard segments relative to the degraded polyester segments increases, until the remaining urethane segment domains further degrade.

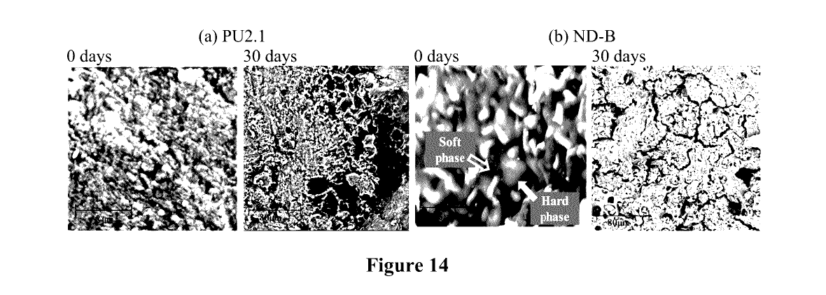

Scanning electron microscopy (SEM) was used to analyze the surface topography of the TPEUs before and after four weeks of hydrolytic degradation. SEM images of pristine PU2.1 and ND-B, and after 30 days of immersion in water at 80° C. are shown in FIG. 14 a and b, respectively.

The pores and cracks which show prominently on the surfaces of the hydrolyzed samples after 30 days of hydrolytic ageing (FIG. 14 a and b, respectively) indicate an extensive accelerated hydrolytic degradation for both PU2.1 and ND-B. The cracks were formed from the shrinking of the degraded surface during drying, caused by the internal stresses. The surface morphology of the degraded samples shown in FIG. 14 is typical of a degradation profile under accelerated hydrolysis where the polymer undergoes molecular weight loss because of chain scission of the polyester segments followed by mass loss via the extraction of water-soluble oligomers. The polyester-rich PU2.1 showed a relatively more extensive degradation at 30 days compared to ND-B which has higher degradation-resistant hard segment content. These findings are in good agreement with similar hydrothermal studies conducted on polyester-based polyurethanes.

Effect of Hydrothermal Ageing on Thermal Behavior

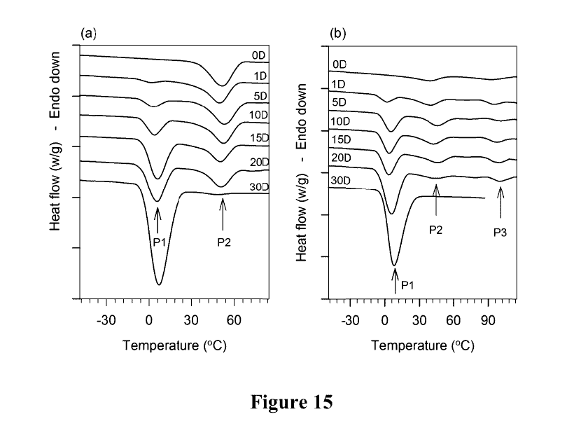

FIGS. 15a and b show DSC thermograms obtained during the 2nd heating cycle of PU2.1 and ND-B samples, respectively, extracted at various immersion times. Note that since the untreated sample showed no melting peak above 85° C. and in order to prevent undue instrument hazard due to water evaporation in the sealed pans above 100° C., the PU2.1 samples were heated up to 85° C. Samples of ND-B extracted after 20 days of immersion were also heated up to 85° C. because of the large amount of water present in the sample.

The endotherm at ˜50° C. (P2 in FIGS. 15a and b) is ascribed to the melting of the soft segment crystals. The endotherm whose onset temperature is below 0° C. (P1 at ˜6° C. in FIGS. 15a and b) is ascribed to the melting of absorbed frozen water by the TPEUs. The endotherm near 95° C. for ND-B (P3 in FIG. 9b) is ascribed to the evaporation of water. Note that the endotherms associated with the evaporation of water shifted to higher melting temperatures as immersion time was increased and water molecules self-associate, inhibiting evaporation. The melting of the urethane segment crystallites corresponding to Tₘ=87° C. for the untreated elastomer (OD in FIG. 15b), was not observed for the hydrolyzed ND-B samples, because of a possible overlap with the endotherm for water evaporation (P3 in FIG. 15b).

A gradual increase in water absorption with immersion time was evident for both TPEUs from the increasing enthalpy of P1 (FIGS. 15a and b). The gradual broadening of P2, the endotherm associated with the polyester soft segment indicates the progress of the hydrolytic degradation in both PU2.1 and ND-B. Furthermore, a shift of P2 to higher temperatures until 5 days which subsequently lowered indicate the presence of organized crystals which later destabilize. The absence of the characteristic endotherm of the soft segment phase (at ˜50 C) after 30 days of immersion for both ND-B and PU2.1 indicates that the crystal structure was destroyed by extensive hydrolysis.

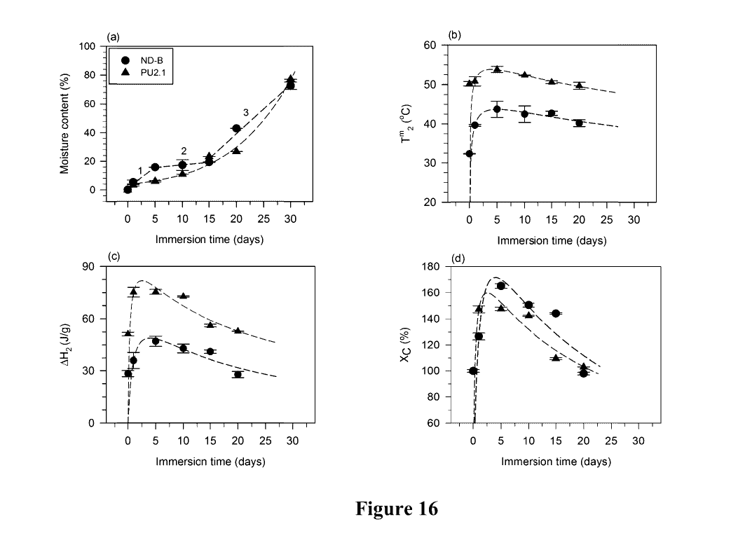

The percentage moisture content was estimated from the ratio of the enthalpy of the ice melting peak of the sample (P1 in FIGS. 15a and b) and pure water which is ΔH=333.5 J/g. The results are presented in FIG. 16a for PU2.1 and ND-B. Although such a quantification ignores the small differences in the enthalpies of ice of various crystals, it allows the determination of moisture content in partially crosslinked polyurethane hydrogels and in thermoplastic poly(ester urethane)s. The evolution of the enthalpy (ΔH), peak melting temperatures (Tₘ) and degree of crystallinity determined from the enthalpy of melting of PU2.1 and ND-B are shown in FIGS. 16b, c and d, respectively.

As shown in FIG. 16a, the moisture content in PU2.1 increased steadily with immersion time indicating that voids due to degradation of the TPEUs were initially created slowly, then much more rapidly in a sigmoidal-like manner (R²>0.9877). In ND-B, the penetration of water was observed in three distinct linear stages. In the first stage (1 in FIG. 16a, 0-5 days), the water was accessed rapidly (3% per day) and penetrated into both the soft and hard segments due to the high phase separation. Interestingly, there was no significant change in the moisture content in the second phase (segment 2, 5 to 15 days, in FIG. 16a). This behavior can be explained by the decreasing phase separation and dispersion of the hard segments observed at this time by FTIR (FIG. 13b) wherein the absorbed water relocates in the matrix. In the third phase (segment 3 in FIG. 16a, 15-30 days), water was absorbed again at a rate similar to the first phase (3% per day) due to the rapid erosion of the polyester segments and the loss of the smaller molecular weight chains which creates new voids that are filled with water. The percent moisture in both PU2.1 and ND-B was the same (20%) at 15 days indicating that the total water uptake by the polyester segments before erosion was independent of the TPEU structure.

The enthalpy and temperature of melting and degree of crystallinity X_{C} in FIG. 16 b, c and d, respectively, initially increased reaching a maximum after 5 days of immersion and then decreased linearly afterward. The initial increase is attributed to the so-called chemicrystallization, a phenomenon commonly observed during the degradation of thermoplastic polyesters and which occurs due to the chain scission in the amorphous segments and subsequent formation of small chains with enough mobility to realign and therefore crystallize.

After 5 days of hydrolysis, the enthalpy and melting temperature and degree of crystallinity of both PU2.1 and ND-B decreased dramatically to a point where the endothermic peaks were no longer detectable by DSC. This is attributable to the continuous erosion of the soft segments which leads to the rapid decrease in crystal size and regularity to an extent at which they are no longer detectable.

An increased initial crystallinity of the hydrolyzed PU2.1 and ND-B samples, due to chemicrystallization and the subsequent degradation of the soft segments resulted in the inability to detect a distinct glass transition temperature for both elastomers.

Effect of Hydrothermal Ageing on Tensile Properties

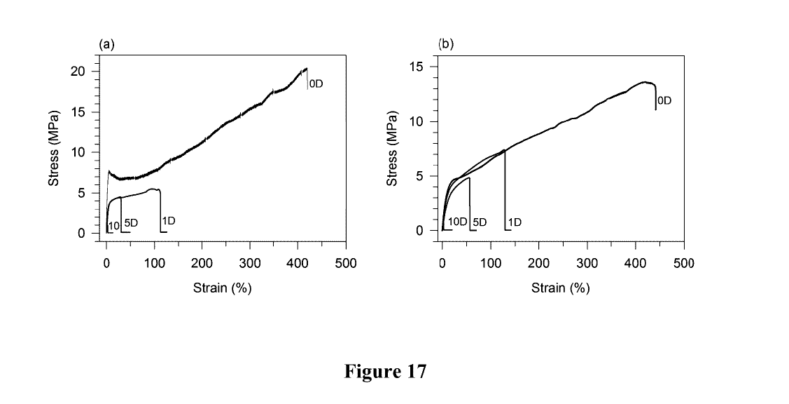

FIGS. 17a and b show the stress-strain curves of the humid PU2.1 and ND-B elastomers extracted at selected hydrolysis times. The related tensile data are summarized in Table 7. Table 7 shows tensile data for the hydrolyzed one-phase and segmented TPEU elastomers at various immersion times (tᵢ).

TABLE 7

| | Ultimate tensilestrength | | Young's | | Maximum strain | |
|---|---|---|---|---|---|---|
| tᵢ | (MPa) | | modulus(MPa) | | (%) | |
| (days) | PU2.1 | ND-B | PU2.1 | ND-B | PU2.1 | ND-B |
| 0 | 18.2 | 14.2 | 253.5 | 49.4 | 353 | 440 |
| 1 | 5.5 | 7.4* | 105.3 | 44.9 | 112 | 127 |
| 5 | 4.5 | 4.9 | 101.9 | 35.3 | 31 | 56 |
| 10 | 1.0 | 0.9 | 40.1 | 25.8 | 3 | 4 |

*tensile half-life

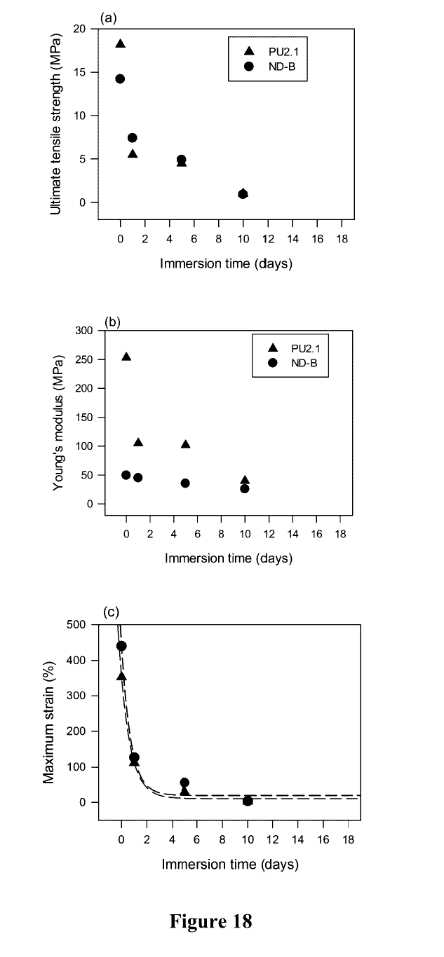

As shown in FIG. 18, after one day of hydrothermal ageing, the tensile properties of PU2.1 and ND-B were considerably reduced. The mechanical properties progressively declined until 15 days when the samples were too brittle to be tested at (FIG. 18, Table 7). The results of the ageing experiments (Table 7) show that hydrolytic degradation at high temperature of PU2.1 and ND-B affected mainly the strain at break (FIG. 18 c) and tensile strength (FIG. 18 a) and much less the modulus (FIG. 18 b). In PU2.1 after 1 day the maximum strain and tensile strength declined by 70%, whereas the modulus dropped by 58%. After 1 day of immersion, ND-B showed a similar decline in elongation (70%), 50% in tensile strength and 10% in modulus. PU2.1 surpassed its tensile half-life, within 1 day of immersion, whereas ND-B reached a tensile half-life after 1 day (Table 7).

Similar losses of mechanical properties have been reported for hydrolyzed ester-based polymers such polyethylene terephthalate and poly(glycolic acid). The decline in mechanical properties was explained by the fragmentation along the tie-chains of the polyester segments which support the crystalline soft segment lamellae to transmit tensile loads. The chain scission of long chain molecules leads to the decrease in entanglement reducing maximum strain.

PU2.1 which is a TPEU with a high polyester content is expected to experience substantial fragmentation of the tie-chains and to present a large loss in tensile strength and modulus at the early stages of hydrothermal ageing. ND-B displayed a similar pattern of early deterioration of elongation also attributed to the fragmentation of its polyester segment tie chains. However, it retained modulus and a certain degree of tensile strength because at this stage, its well separated urethane phase was less affected by degradation and provided effective load bearing junctions.

Between 1 and 5 days, an insignificant decline in tensile strength and modulus was observed in PU2.1 attributed to the consideration of chemicrystallization of fragmented chains as revealed by the gradual decrease in enthalpy observed by DSC for the peak associated with the melting of the polyester soft segment phase during this time (FIG. 16b). ND-B showed a larger deterioration in tensile strength and modulus than PU2.1 attributed to the plasticization caused by the penetration of water in the dispersed urethane segments reducing their load bearing capacity. The correlation between the continued deterioration of mechanical properties after 5 days and the drop in crystallinity as revealed by the enthalpy of melting of PU2.1 and ND-B indicate that hydrolysis degrades the tie-chain segments up to a point where all are fragmented leading to a brittle failure. Such failure occurred at 10 days in both TPEUs.

Interestingly, the deterioration of mechanical properties of TPEUs prior to extensive molecular weight decay or mass loss and resulting in the formation of carboxylic acid degradation products is characteristic of resorbable polymers used as scaffolds for tissue regeneration, highlighting the potential for entirely lipid-derived aliphatic TPEUs as credible candidates in biomedical applications.

Effect of Hydrothermal Ageing on Thermal Decomposition and Mass Loss

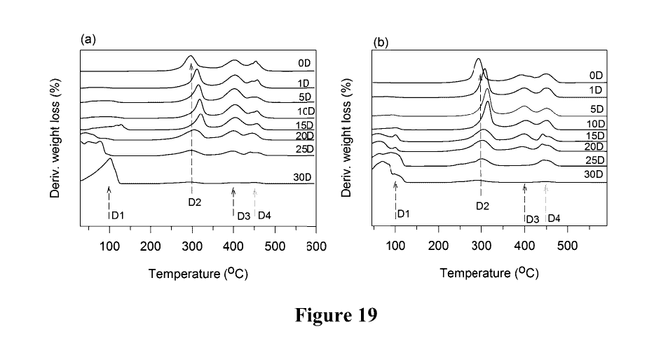

The effect of hydrolytic ageing on thermal decomposition was determined by TGA. The DTG curves of PU2.1 and ND-B are shown in FIGS. 19a and b, respectively. The weight loss steps for the decomposition of the C—NH (urethane segments), C—O (polyester segments) and the C—C bonds (pyrolysis of the aliphatic chains) are noticeable in their known characteristic temperature ranges near 300° C., 400° C. and 450° C., respectively. The weight loss below 150° C. (D1 in FIG. 19 a and b) is attributed to the evaporation of water.

A common pattern of decomposition was evident in both polymers. Firstly, there was a gradual increase in the evaporation of moisture below 100° C. (D1 in FIG. 19) reaching a maximum at 30 days, commensurate with the increased absorption of water shown by DSC (FIG. 16a). Secondly, the C—NH decomposition temperature (arrow in FIG. 19) shifts to a higher temperature until 10-15 days after which it shifts back to lower values.

Free N—H bonds in the hard segments act as oxygen bonding sites and the C═O groups provide acceptor sites for the protons of the penetrating water molecules effectively integrating water as a bridge between the N—H and C═O groups or between two carbonyl groups, resulting in stable hard segment structures with new inter-urethane hydrogen-bonds that delay decomposition. However, with further hydrolysis (i.e. after 15 days of immersion), the excess water disrupts the hard segment bonding, forming weaker polymer-water interactions. Self-aggregated water molecules are evaporated earlier and the un-degraded water-free C—NH bonds then regain their initial decomposition temperature. The delay in decomposition due to the formation of new inter-urethane hydrogen bonds is supported by the increase in R and DPS as quantified by FTIR in phase II of the hydrothermal ageing process (FIG. 13).

Thirdly, the DTG peak of C—NH (D2 in FIG. 19) remained consistently higher than those of the C—O and C—C bonds (D3 and D4, respectively, in FIG. 19) indicating that their relative rate of degradation was preserved.

The DTG peak corresponding to the ester degradation was absent after 25 days in ND-B and after 30 days in PU2.1, suggesting that stable intermediates which reduce the number of degradation stages were formed. This indicates that the slower degrading residual urethane groups offer a stabilization effect that mitigates polyester degradation. A similar stabilization of the polyester segment decomposition by the crystalline urethane segments has been observed in TPEUs.

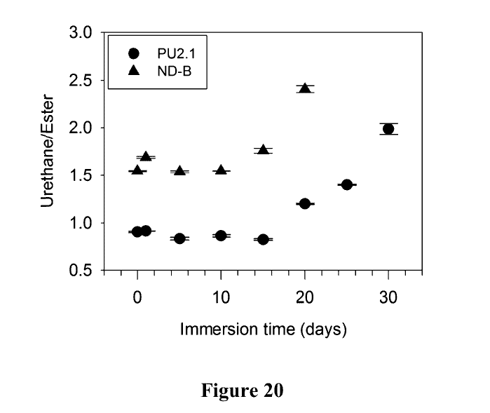

FIG. 20 shows the relative decomposition of the urethane and ester groups determined from the percent weight loss of the C—NH and the C—O groups. As can be seen in the figure, up to 15 days, the ratio of urethane to ester groups' weight loss was only slightly higher in ND-B than PU2.1 (0.9 for PU2.1 and 1.5 for ND-B) indicating that there was an equal rate of mass loss for both segments. At this stage, the mass loss of either species did not vary from one sample to the other, probably because although the erosion resulted in smaller fragments, they “chemicrystallized”, i.e., reorganized without diffusing out of the material. These arguments are supported by the GPC data and also by the percentage weight loss in FIG. 10c. After 15 days the relative decomposition of the urethane and ester groups increased sharply despite a significant increase in the urethane weight loss. This is explained by the progressive loss of the polyester fragments out of the material at a much higher rate than the urethane groups due to their higher susceptibility to erosion.

### CONCLUSIONS

Elastomeric, entirely lipid-derived segmented thermoplastic poly(ester urethane)s (TPEU) were synthesized from oleic acid derived polyester diols, 1,7-heptamethylene diisocyanate and 1,9-nonandiol. Phase separation, molecular weight, hydrogen bond density and thus hard segment distribution and crystallinity of the TPEUs were controlled by varying the polymerization protocol. The study demonstrates that the polymerization procedure can be customized for both hydrogen bond density and phase separation. The TPEUs which were produced using this approach presented very high molecular weight and excellent phase separation and showed rubber-like elastomeric properties. Their mechanical properties are superior to those of any other fully lipid-derived TPEUs reported in literature so far and compare very favorably to commercial petroleum based counterparts.

The hydrothermal ageing was shown to affect the morphological structure of the TPEU in a complex manner. PU2.1 and ND-B both displayed bulk degradation irrespective of their phase structure, showing deterioration of mechanical properties prior to significant mass loss. Three phases were observed in the hydrolytic degradation of the both one-phase and segmented TPEU elastomers. In both cases, the degradation started with the scission of the soft segments; followed by a step in which although the erosion resulted in smaller fragments, they reorganized without diffusing out of the material in what is known as “chemicrystallization”, and in lastly the acceleration of the degradation of the ester phase leading to a brittle failure. Extensive hydrolysis resulted in the degradation of both the soft and hard segment domains after 30 days of ageing as evidenced by the analysis of the degradation products by ¹H-NMR. The structure of the phase separated TPEU was revealed to offer a somehow higher protection against thermal ageing through its nanoscale crystalline load bearing phase than the continuous structure of the one-phase TPEU. The two-phase ND-B also showed a higher resistance to degradation than the one-phase PU2.1 based on the SEM images.

The continued deterioration of the mechanical properties of the TPEUs was related to the loss of molecular weight and PDI and directly correlated to the drop in crystallinity as revealed by DSC. Noticeably, the TPEU of the present work showed a very short tensile half-life, indicating that they are easily fragmentable and can significantly biodegrade after a successful service life.

### REFERENCES

1. Szycher, M., Szycher's handbook of polyurethanes. CRC press: 1999.
2. Szycher, M., Structure-property relations in polyurethanes. Szycher's Handbook of Polyurethanes 2012, 37.
3. Ibeh, C. C., Thermoplastic Materials: Properties, Manufacturing Methods, and Applications. CRC Press: 2011.
4. Skarja, G.; Woodhouse, K., Structure-property relationships of degradable polyurethane elastomers containing an amino acid-based chain extender. Journal of applied polymer science 2000, 75, (12), 1522-1534.
5. Lligadas, G.; Ronda, J. C.; Galia, M.; Cadiz, V., Renewable polymeric materials from vegetable oils: a perspective. Materials Today 2013, 16, (9), 337-343.
6. Miao, S.; Wang, P.; Su, Z.; Zhang, S., Vegetable-oil-based polymers as future polymeric biomaterials. Acta biomaterialia 2014, 10, (4), 1692-1704.
7 Li, S.; Jose, J.; Bouzidi, L.; Leao, A. L.; Narine, S. S.; Maximizing the utility of biobased diisocyanate and chain extenders in crystalline thermoplastic segmented polyester urethanes: Effect of polymerization protocol, Polymer, 2014, 55(26), 6764-6775
8. Hojabri, L.; Jose, J.; Leao, A. L.; Bouzidi, L.; Narine, S. S., Synthesis and physical properties of lipid-based poly (ester-urethane) s, I: Effect of varying polyester segment length. Polymer 2012, 53 (17), 3762-3771.
9. Hojabri, L.; Kong, X.; Narine, S. S., Functional thermoplastics from linear diols and diisocyanates produced entirely from renewable lipid sources. Biomacromolecules 2010, 11, (4), 911-918.
10. Gopferich, A., Mechanisms of polymer degradation and elimination. Handbook of biodegradable polymers 1998, 7, 451.
11. Petrovic, Z. S., Polyurethanes from vegetable oils. Polym Rev 2008, 48, (1), 109-155.
12. Blundell, D. J.; Eeckhaut, G.; Fuller, W.; Mahendrasingam, A.; Martin, C., Real time SAXS/stress-strain studies of thermoplastic polyurethanes at large strains. Polymer 2002, 43, (19), 5197-5207.
13. Saralegi, A.; Rueda, L.; Fernandez-d'Arlas, B.; Mondragon, I.; Eceiza, A.; Corcuera, M., Thermoplastic polyurethanes from renewable resources: effect of soft segment chemical structure and molecular weight on morphology and final properties. Polymer International 2013, 62, (1), 106-115.
14. Das, S.; Cox, D. F.; Wilkes, G. L.; Klinedinst, D. B.; Yilgor, I.; Yilgor, E.; Beyer, F. L., Effect of Symmetry and H-bond Strength of Hard Segments on the Structure-Property Relationships of Segmented, Nonchain Extended Polyurethanes and Polyureas. Journal of Macromolecular Science, Part B: Physics 2007, 46, (5), 853-875.
15. Kim, B. K.; Lee, S. Y.; Xu, M., Polyurethanes having shape memory effects. Polymer 1996, 37, (26), 5781-5793.
16. Peebles Jr, L., Sequence length distribution in segmented block copolymers. Macromolecules 1974, 7, (6), 872-882.
17. Peebles, L. H., Hard Block Length Distribution in Segmented Block Copolymers. Macromolecules 1976, 9, (1), 58-61.
18. Pretsch, T.; Jakob, I.; Müller, W., Hydrolytic degradation and functional stability of a segmented shape memory poly (ester urethane). Polymer degradation and stability 2009, 94, (1), 61-73.
19. Mondal, S.; Martin, D., Hydrolytic degradation of segmented polyurethane copolymers for biomedical applications. Polymer degradation and stability 2012, 97, (8), 1553-1561.
20. Pegoretti, A.; Kolarik, J.; Penati, A., Hydrolytic stability and mechanical properties of poly (ester urethanes). Die Angewandte Makromolekulare Chemie 1994, 220, (1), 49-60.
21. Fambri, L.; Penati, A.; Kolarik, J., Synthesis and hydrolytic stability of model poly (ester urethane ureas). Die Angewandte Makromolekulare Chemie 1995, 228, (1), 201-219.
22. Pegoretti, A.; Penati, A.; Kolarik, J., Effect of hydrolysis on molar mass and thermal properties of poly (ester urethanes). Journal of thermal analysis 1994, 41, (6), 1441-1452.
23. Chu, C., Hydrolytic degradation of polyglycolic acid: tensile strength and crystallinity study. Journal of applied polymer science 1981, 26, (5), 1727-1734.
24. Furukawa, M.; Shiiba, T.; Murata, S., Mechanical properties and hydrolytic stability of polyesterurethane elastomers with alkyl side groups. Polymer 1999, 40, (7), 1791-1798.
25. John, S., Compositional and Failure Analysis of Polymers. In John Wiley & Sons, Ltd: 1999.
26. Thompson, D. G.; Osborn, J. C.; Kober, E. M.; Schoonover, J. R., Effects of hydrolysis-induced molecular weight changes on the phase separation of a polyester polyurethane. Polymer degradation and stability 2006, 91, (12), 3360-3370.
27. Padsalgikar, A.; Cosgriff-Hernandez, E.; Gallagher, G.; Touchet, T.; Iacob, C.; Mellin, L.; Norlin-Weissenrieder, A.; Runt, J., Limitations of predicting in vivo biostability of multiphase polyurethane elastomers using temperature-accelerated degradation testing. Journal of Biomedical Materials Research Part B—Applied Biomaterials 2015, 103, (1), 159-168.
28. Nakamae, K.; Yamaguchi, K.; Asaoka, S.; Karube, Y., Lifetime expectancy of polyurethane binder as magnetic recording media. International journal of adhesion and adhesives 1996, 16, (4), 277-283.
29. Shetranjiwalla, S.; Li, S.; Bouzidi, L.; Narine, S. S., Imparting elastomeric properties to entirely lipid-derived thermoplastic poly(ester urethane)s: Molecular weight control. Polymer, 2016, 92 (1), 140-152.
30. Hojabri, L.; Kong, X.; Narine, S. S., Fatty acid-derived diisocyanate and biobased polyurethane produced from vegetable oil: synthesis, polymerization, and characterization. Biomacromolecules 2009, 10, (4), 884-891.
31. Müller, W. W.; Pretsch, T., Hydrolytic aging of crystallizable shape memory poly (ester urethane): Effects on the thermo-mechanical properties and visco-elastic modeling. European Polymer Journal 2010, 46, (8), 1745-1758.
32. Coleman, M. M.; Lee, K. H.; Skrovanek, D. J.; Painter, P. C., Hydrogen bonding in polymers. 4. Infrared temperature studies of a simple polyurethane. Macromolecules 1986, 19, (8), 2149-2157.
33. Seymour, R.; Estes, G.; Cooper, S., Infrared studies of segmented polyurethan elastomers. I. Hydrogen bonding. Macromolecules 1970, 3, (5), 579-583.
34. Vogel, A. I., text-book of practical organic chemistry. 1948.
35. Lenz, R. W., Organic chemistry of synthetic high polymers. 1967.
36. Velankar, S.; Cooper, S. L., Microphase separation and rheological properties of polyurethane melts. 1. Effect of block length. Macromolecules 1998, 31, (26), 9181-9192.
37. Li, Y.; Gao, T.; Liu, J.; Linliu, K.; Desper, C. R.; Chu, B., Multiphase structure of a segmented polyurethane: effects of temperature and annealing. Macromolecules 1992, 25, (26), 7365-7372.
38. Cowie, J. M. G.; Arrighi, V., Polymers: chemistry and physics of modern materials. CRC press: 2007.
39. Chattopadhyay, D.; Webster, D. C., Thermal stability and flame retardancy of polyurethanes. Progress in Polymer. Science 2009, 34, (10), 1068-1133.
40. Chrissafis, K.; Paraskevopoulos, K.; Papageorgiou, G.; Bikiaris, D., Thermal decomposition of poly (propylene sebacate) and poly (propylene azelate) biodegradable polyesters: evaluation of mechanisms using TGA, FTIR and GC/MS. Journal of Analytical and Applied Pyrol 2011, 92, (1), 123-130.
41. Król, P., Synthesis methods, chemical structures and phase structures of linear polyurethanes. Properties and applications of linear polyurethanes in polyurethane elastomers, copolymers and ionomers. Progress in materials science 2007, 52, (6), 915-1015.
42. Qi, H.; Boyce, M., Stress-strain behavior of thermoplastic polyurethanes. Mechanics of Materials 2005, 37, (8), 817-839.
43. Davis, J. R., Tensile testing. ASM international: 2004.
44. Korley, L. T. J.; Pate, B. D.; Thomas, E. L.; Hammond, P. T., Effect of the degree of soft and hard segment ordering on the morphology and mechanical behavior of semicrystalline segmented polyurethanes. Polymer 2006, 47, (9), 3073-3082.
45. Kennedy, M.; Peacock, A.; Mandelkern, L., Tensile properties of crystalline polymers: linear polyethylene. Macromolecules 1994, 27, (19), 5297-5310.
46 Brown, D. W.; Lowry, R. E.; Smith, L. E., Kinetics of hydrolytic aging of polyester urethane elastomers. Macromolecules 1980, 13, (2), 248-252.
47. Lyu, S.; Untereker, D., Degradability of polymers for implantable biomedical devices. International Journal of Molecular Sciences 2009, 10, (9), 4033-4065.
48. Mitchell, M. K.; Hirt, D. E., Degradation of PLA fibers at elevated temperature and humidity. Polymer Engineering & Science 2014.
49. Mequanint, K.; Patel, A.; Bezuidenhout, D., Synthesis, Swelling Behavior, and Biocompatibility of Novel Physically Cross-Linked Polyurethane-b lock-Poly (glycerol methacrylate) Hydrogels. Biomacromolecules 2006, 7, (3), 883-891.
50. Mathisen, T.; Lewis, M.; Albertsson, A. C., Hydrolytic degradation of nonoriented poly (β-propiolactone). Journal of applied polymer science 1991, 42, (8), 2365-2370.
51. Wang, R.; Wang, Q.; Li, L., Evaporation behaviour of water and its plasticizing effect in modified poly (vinyl alcohol) systems. Polymer International 2003, 52, (12), 1820-1826.
52. Sammon, C.; Yarwood, J.; Everall, N., An FT-IR study of the effect of hydrolytic degradation on the structure of thin PET films. Polymer Degradation and Stability 2000, 67, (1), 149-158.
53. Coutinho, F. M.; Delpech, M. C., Degradation profile of films cast from aqueous polyurethane dispersions. Polymer Degradation and Stability 2000, 70, (1), 49-57.
54. Holmberg, A. L.; Reno, K. H.; Wool, R. P.; Epps I. I. I. T. H., Biobased building blocks for the rational design of renewable block polymers. Soft Matter 2014, 10 (38), 7405-7324.
55. Mishra, A.; Maiti P., Morphology of polyurethanes at various length scale: the influence of chain structure. Journal of Applied Polymer Science 2011, 120 (6) 3546-3555.
56. Xu, Y.; Petrovic, Z.; Das, S.; Wilkes G. L., Morphology and properties of thermoplastic polyurethanes with dangling chains in ricinoleate-based soft segments. Polymer, 2008 49 (19), 4248-4258.
57. Por [symbol] ba, R.; Kredatusová, J.; Hodan, J.; Serkis, M.; \check{S}pirková, M., Thermal and mechanical properties of multiple-component aliphatic degradable polyurethanes. Journal of Applied Polymer Science 132, (2015).
58. \check{S}pirková, M.; Machová, L.; Kobera, L.; Brus, J.; Por [symbol] ba, R.; Serkis, M.; Zhigunov, A., Multiscale approach to the morphology, structure, and segmental dynamics of complex degradable aliphatic polyurethanes. Journal of Applied Polymer Science 2015, 132 (16), 41872.
59. Menges, M. G.; Penelle, J.; Le Fevere de Ten Hove, C.; Jonas, A. M.; Schmidt-Rohr, K., Characterization of Long-Chain Aliphatic Polyesters: Crystalline and Supramolecular Structure of PE22,4 Elucidated by X-ray Scattering and Nuclear Magnetic Resonance. Macromolecules 2007, 40 (24), 8714-8725.
60. Liau, W. B.; Boyd, R. H., Structure and packing in crystalline aliphatic polyesters. Macromolecules 1990, 23 (5), 1531-1539.
61. Zuo, J.; Li, S.; Bouzidi, L.; Narine, S. S., Thermoplastic polyester amides derived from oleic acid. Polymer 2011, 52 (20), 4503-4516.
62. Ducheyne, P.; Healy, K.; Hutmacher, D. E.; Grainger, D. W.; Kirkpatrick C. J., Comprehensive Biomaterials: Online Version, Elsevier 2011.
63. Lamba, N. M.; Woodhouse, K. A.; Cooper, S. L., Polyurethanes in biomedical applications, CRC press 1997.
64. Miller-Chou, B. A.; Koenig, J. L., A review of polymer dissolution, Progress in Polymer Science, 2003 28 (8) 1223-1270.
65. Odian, G., Principles of polymerization, fourth ed., John Wiley & Sons, New York, 2004.
66. Puffr, R.; \check{S}ebenda, J., On the Structure and Properties of Polyamides. XXVII. The Mechanism of Water Sorption in Polyamides, Journal of Polymer Science Part C: Polymer Symposia 1967, 16 (1) 79-93.
67. Dempsey, D. K.; Robinson, J. L.; Iyer, A. V.; Parakka, J. P.; Bezwada, R. S.; Cosgriff-Hernandez, E. M., Characterization of a resorbable poly (ester urethane) with biodegradable hard segments, J Biomaterials Science Polymer Edition 2014, 25 (6) 535-554.
68. Tsou, C-H.; Lee, H-T.; Tsai, H-A.; Cheng, H-J.; Suen, M-C., Synthesis and properties of biodegradable polycaprolactone/polyurethanes by using 2, 6-pyridinedimethanol as a chain extender, Polymer Degradation and Stability 2013, 98 (2) 643-650.
69. Gajjar, C. R., King, M. W., Resorbable Fiber-forming Polymers for Biotextile Applications, Springer 2014.
70. Wang, T-L., Hsieh, T-H., Effect of polyol structure and molecular weight on the thermal stability of segmented poly (urethaneureas), Polymer Degradation and Stability 1997, 55 (1) 95-102.

1. A polymer composition, comprising one or more urethane polymers formed from a first reaction mixture, which comprises chain-extending monomers and diisocyanate-terminated poly(ester urethane) prepolymers;
wherein the diisocyanate-terminated poly(ester urethane) prepolymers are formed from a second reaction mixture, which comprises C₂₋₄₀ diisocyanates and dihydroxyl-terminated polyesters; and
wherein the dihydroxyl-terminated polyesters are formed from a third reaction mixture, which comprises C₉₋₂₂ diols and C₇₋₂₂ dicarboxylic acids or esters thereof.

2. The polymer composition of claim 1, wherein the chain-extending monomers comprise diols, diamines, or combinations thereof.

3. The polymer composition of claim 2, wherein the chain-extending monomers comprise C₉₋₂₂ diols, C₉₋₂₀diols, or C₉₋₁₈diols, or C₉₋₁₆diols or 1,9-nonanediol.

4. The polymer composition of claim 1, wherein the C₂₋₄₀ diisocyanates are C₂₋₃₀diisocyanates, or C₃₋₂₀diisocyanates, or C₄₋₁₅diisocyanates, or C₅₋₁₀diisocyanates, or 1,7-heptamethylene diisocyanate.

5. The polymer composition of claim 1, wherein the C₉₋₂₂ diols comprised by the third reaction mixture are C₉₋₂₀diols, or C₉₋₁₈diols, or C₉₋₁₆diols or 1,9-nonanediol.

6. The polymer composition of claim 1, wherein the C₇₋₂₂ dicarboxylic acids or esters thereof are C₇₋₂₀dicarboxylic acids, or C₇₋₁₈dicarboxylic acids, C₇₋₁₆dicarboxylic acids, or esters of thereof or azelaic acid or esters thereof.

7. The polymer composition of claim 1, wherein the dihydroxyl-terminated polyesters have a number-average molecular weight (Mₙ) of at least 3000 g/mol, or at least 3500 g/mol, or at least 4000 g/mol, or at least 4500 g/mol.

8. The polymer composition of claim 1, wherein the dihydroxyl-terminated polyesters have a polydispersity index ranging from 1 to 2.

9. The polymer composition of claim 1, wherein, upon immersing the one or more urethane polymers in water at 80° C. for 30 days, the one or more polymers degrade into one or more hydrolyzed products, the one or more hydrolyzed products having a weight-average molecular weight (M_{w}) of no more than 4000 g/mol.

10. A polymer composition, comprising one or more urethane polymers formed from a first reaction mixture, which comprises diisocyanate-terminated prepolymers and dihydroxyl-terminated polyesters;
wherein the diisocyanate-terminated prepolymers are formed from a second reaction mixture, which comprises C₂₋₄₀ diisocyanates and chain-extending monomers; and
wherein the dihydroxyl-terminated polyesters are formed from a third reaction mixture, which comprises C₉₋₂₂ diols and C₇₋₂₂ dicarboxylic acids or esters thereof.

11. The polymer composition of claim 10, wherein the chain-extending monomers comprise diols, diamines, or combinations thereof.

12. The polymer composition of claim 11, wherein the chain-extending monomers comprise C₉₋₂₂ diols, C₉₋₂₀diols, or C₉₋₁₈diols, or C₉₋₁₆diols, 1,9-nonanediol.

13. The polymer composition of claim 10, wherein the C₂₋₄₀ diisocyanates are C₂₋₃₀ diisocyanates, or C₃₋₂₀ diisocyanates, or C₄₋₁₅ diisocyanates, or C₅₋₁₀ diisocyanates or 1,7-heptamethylene diisocyanate.

14. The polymer composition of claim 10, wherein the C₉₋₂₂ diols comprised by the third reaction mixture are C₉₋₂₀ diols, or C₉₋₁₈ diols, or C₉₋₁₆ diols or 1,9-nonanediol.

15. The polymer composition of claim 10, wherein the C₇₋₂₂ dicarboxylic acids or esters thereof are C₇₋₂₀ dicarboxylic acids, or C₇₋₁₈ dicarboxylic acids, C₇₋₁₆ dicarboxylic acids, or esters of thereof or azelaic acid or esters thereof.

16. The polymer composition of claim 10, wherein the dihydroxyl-terminated polyesters have a number-average molecular weight (Mₙ) of at least 3000 g/mol, or at least 3500 g/mol, or at least 4000 g/mol, or at least 4500 g/mol.

17. The polymer composition of claim 10, wherein the dihydroxyl-terminated polyesters have a polydispersity index ranging from 1 to 2.

18. The polymer composition of claim 10, wherein, upon immersing the one or more urethane polymers in water at 80° C. for 30 days, the one or more polymers degrade into one or more hydrolyzed products, the one or more hydrolyzed products having a weight-average molecular weight (M_{w}) of no more than 4000 g/mol.

19. The polymer composition of claim 10, wherein the polymer composition exhibits one or more of the following properties:
an increased enthalpy of melting ranging from 26.3 J/g to 77.4 J/g following immersion of the polymer composition in water for 5 days at 80° C.; or
a decreased enthalpy of about 28 J/g following immersion of the polymer composition in water for 20 days at 80° C.

20. The polymer composition of claim 10, wherein the polymer composition undergoes tensile failure in no more than 10 days of immersion in water at 80° C.
